(19) United States
(12) Patent Application Publication
(10) Pub. No.: US 2025/0039319 A1
(43) Pub. Date: Jan. 30, 2025

(54) IMAGE FORMING APPARATUS, CONVEYANCE CONTROL METHOD AND NON-TRANSITORY COMPUTER-READABLE RECORDING MEDIUM ENCODED WITH CONVEYANCE CONTROL PROGRAM

(71) Applicant: Konica Minolta, Inc., Tokyo (JP)

(72) Inventors: Noriyuki JINBO, Hamamatsu-shi (JP); Takahiro TSUJIMOTO, Toyokawa-shi (JP); Akinori KIMATA, Toyokawa-shi (JP); Kenichi HAYASHI, Anjo-shi (JP); Shiro UMEDA, Toyokawa-shi (JP)

(21) Appl. No.: 18/784,277

(22) Filed: Jul. 25, 2024

(30) Foreign Application Priority Data
Jul. 28, 2023 (JP) 2023-123399

(51) Int. Cl. H04N 1/23; H04N 1/00

(52) U.S. Cl. CPC H04N 1/2323; H04N 1/00724; H04N 1/00779; H04N 2201/0094

(57) ABSTRACT

An image forming apparatus includes a conveyor that successively conveys a plurality of recording media, a medium detector that detects information about the recording medium conveyed by the conveyor, and a hardware processor, wherein the hardware processor detects the information about the recording medium being conveyed firstly by the conveyor at a first speed by using the media detector, and outputs a conveyance speed of the recording medium determined based on the detected information, and in a case in which the output conveyance speed is different from the first speed, carries out control such that a conveyance speed of at least one of recording media which are conveyed secondly and subsequently by the conveyor and are conveyed later than a recording medium being conveyed firstly is a second speed different from the first speed.

### CROSS-REFERENCE TO RELATED APPLICATIONS

The entire disclosure of Japanese patent Applications No. 2023-123399 filed on Jul. 28, 2023 is incorporated herein by reference in its entirety.

### BACKGROUND OF THE INVENTION

### Technical Field

The present invention relates to an image forming apparatus, a conveyance control method and a non-transitory computer-readable recording medium encoded with a conveyance control program. In particular, the present invention relates to an image forming apparatus that forms images while conveying a recording medium, a conveyance control method executed by the image forming apparatus, and a non-transitory computer-readable recording medium encoded with a conveyance control program that causes a computer controlling the image forming apparatus to execute the conveyance control method.

### Description of Related Art

In an image forming apparatus such as an MFP (Multi Function Peripheral), sheets are taken out one by one from a cassette storing a plurality of sheets to be conveyed, and an image is formed on a sheet being conveyed.

This MFP detects the paper type of a recording medium and forms an image on the recording medium according to an image forming condition corresponding to the paper type. Japanese Unexamined Patent Publication No. 2018-106112 describes an image forming apparatus that stores media characteristics of a recording material and interrupts an image forming process in a case in which first media characteristics of a recording material being conveyed, with the first media characteristics being detected by a media sensor, and second media characteristics of a recording material stored during last image formation are different from each other, and an image forming condition corresponding to the first media characteristics and an image forming condition corresponding to the second media characteristics are different from each other.

However, because the image forming apparatus described in Japanese Unexamined Patent Publication No. 2018-106112 interrupts the image forming process, the image forming process is not continued. Therefore, there is a problem that a user has to eliminate an obstacle, and is required to perform a complicated operation.

### SUMMARY OF THE INVENTION

According to one aspect of the present invention, an image forming apparatus includes a conveyor that successively conveys a plurality of recording media, a medium detector that detects information about the recording medium conveyed by the conveyor; and a hardware processor, wherein the hardware processor detects the information about the recording medium being conveyed firstly by the conveyor at a first speed by using the media detector, and outputs a conveyance speed of the recording medium determined based on the detected information, and in a case in which the output conveyance speed is different from the first speed, carries out control such that a conveyance speed of at least one of recording media which are conveyed secondly and subsequently by the conveyor and are conveyed later than a recording medium being conveyed firstly is a second speed different from the first speed.

According to another aspect of the present invention, a conveyance control method is performed in an image forming apparatus, wherein the image forming apparatus includes a conveyor that successively conveys a plurality of recording media, and a medium detector that detects information about the plurality of recording media conveyed by the conveyor, and the conveyance control method includes an output step of detecting the information about the recording medium being conveyed firstly by the conveyor at a first speed by using the media detector, and outputting a conveyance speed of the recording medium determined based on the detected information, and a conveyance control step of, in a case in which the conveyance speed output in the output step is different from the first speed, carries out control such that a conveyance speed of at least one of recording media which are conveyed secondly and subsequently by the conveyor and are conveyed later than a recording medium being conveyed firstly is a second speed different from the first speed.

According to yet another aspect of the present invention, a non-transitory computer-readable recording medium that is encoded with a conveyance control program executed in a computer controlling an image forming apparatus, wherein the image forming apparatus includes a conveyor that successively conveys a plurality of recording media, and a medium detector that detects information about the plurality of recording media conveyed by the conveyor, and the conveyance control program causes the computer to perform an output step of detecting the information about the recording medium being conveyed firstly by the conveyor at a first speed by using the media detector and outputting a conveyance speed of the recording medium determined based on the detected information, and a conveyance control step of, in a case in which the conveyance speed output in the output step is different from the first speed, carrying out control such that a conveyance speed of at least one of recording media which are conveyed secondly and subsequently by the conveyor and are conveyed later than a recording medium being conveyed firstly is a second speed different from the first speed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view illustrating the appearance of an MFP in the present embodiment;

FIG. 2 is a block diagram illustrating the outline of the hardware configuration of an MFP;

FIG. 3 is a schematic side view illustrating the inner configuration of part of an image forming section and a sheet feed section;

FIG. 4 is a side view illustrating a detection area in a conveyance path;

FIG. 5 is a diagram illustrating one example of the functions of a CPU of the MFP in the present embodiment;

FIG. 6 is a diagram illustrating one example of a type table;

FIG. 7 is a diagram illustrating one example of a speed table;

FIG. 8 is a flowchart illustrating one example of a flow of a conveyance control process;

FIG. 9 is a flowchart illustrating one example of a flow of a first image forming process;

FIG. 10 is a flowchart illustrating one example of a flow of a second image forming process;

FIG. 11 is a diagram illustrating one example of a time chart;

FIG. 12 is a diagram illustrating one example of a change in image forming condition with respect to one example of a change in type of a recording medium; and

FIG. 13 is a diagram illustrating one example of a time chart in a first modification example.

### DETAILED DESCRIPTION

Hereinafter, one or more embodiments of the present invention will be described with reference to the drawings. However, the scope of the invention is not limited to the disclosed embodiments.

An image forming apparatus in embodiments of the present invention will be described below with reference to the drawings. In the following description, the same components are denoted by the same reference numerals. Their names and functions are the same. Therefore, a detailed description thereof will not be repeated. Further, in the following description, an MFP is explained as one example of the image forming apparatus. Further, in the MFP described below, a sheet such as a plain paper, a wood free paper, a recycled paper or a photo paper, or an overlay paper having two sheets being overlaid on each other similarly to an envelope, is used as a recording medium on which an image is to be formed.

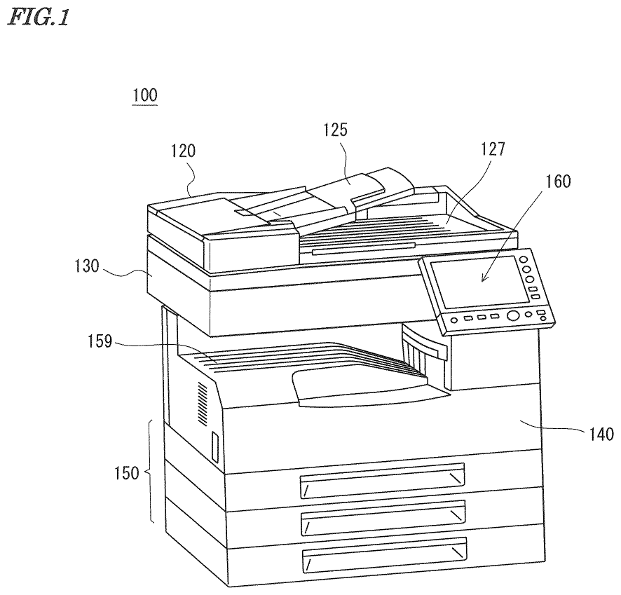

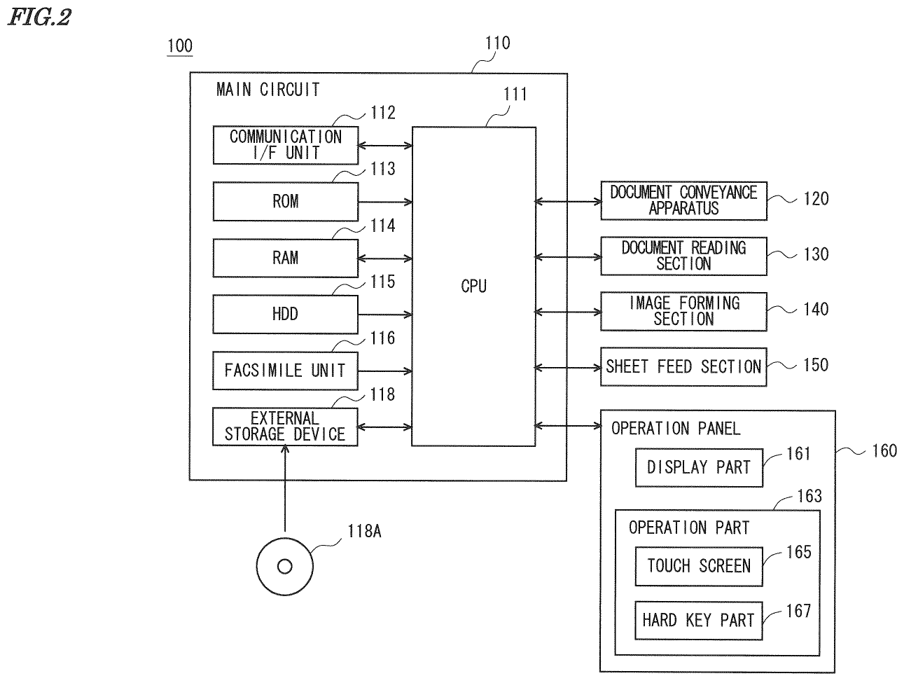

FIG. 1 is a perspective view illustrating the appearance of an MFP in the present embodiment. FIG. 2 is a block diagram illustrating the outline of the hardware configuration of the MFP. With reference to FIGS. 1 and 2, the MFP 100 is one example of an image forming apparatus, and includes a main circuit 110, a document reading section 130 for reading a document, an automatic document conveyance apparatus 120 for conveying a document to the document reading section 130, the image forming section 140 for forming an image on a recording medium based on image data, the sheet feed section 150 for feeding a recording medium to the image forming section 140 and an operation panel 160 serving as a user interface.

The automatic document conveyance apparatus 120 automatically conveys a plurality of documents set on a document tray 125 to a document reading position of the document reading section 130 one by one, and discharges a document having an image formed thereon and read by the document reading section 130 onto a document ejection tray 127. The automatic document conveyance apparatus 120 includes a document detection sensor for detecting a document placed on the document tray 125.

The document reading section 130 includes a light source that emits light and an optoelectronic transducer that receives light, and scans an image formed on a document placed on a reading surface. In a case in which a document is placed on the reading surface, light emitted from the light source is reflected from the document, and the reflected light forms an image on the optoelectronic transducer. When receiving the light reflected from the document, the optoelectronic transducer produces image data by converting the received light into an electrical signal. The document reading section 130 outputs the image data to a CPU 111 included in the main circuit 110.

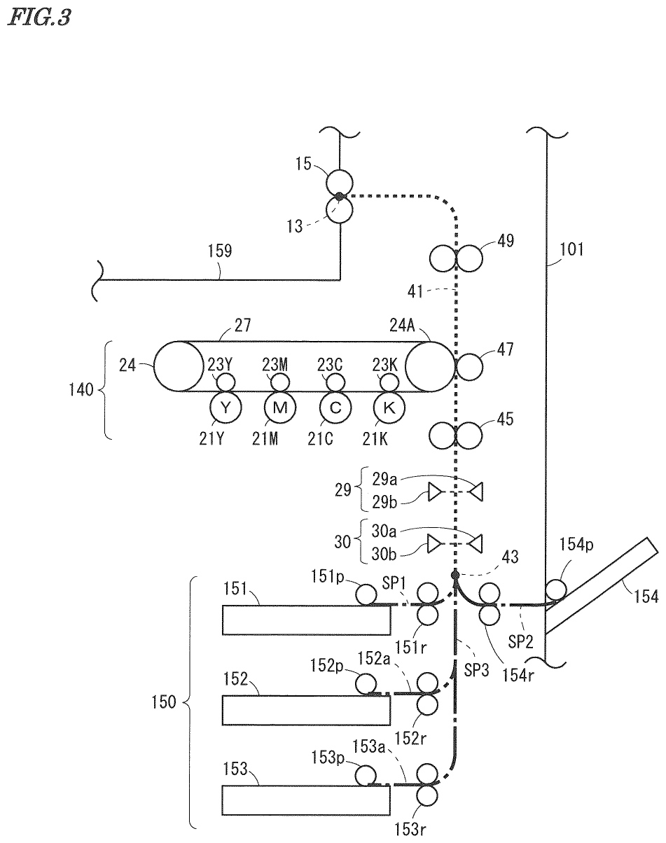

The sheet feed section 150 takes out a recording medium stored in any of three sheet feed trays 151, 152, 153 and a manual sheet feed tray 154 (see FIG. 3), described below, conveys the recording medium to the image forming section 140.

The image forming section 140 is controlled by the CPU 111 and forms an image on the recording medium that is conveyed by the sheet feed section 150 using a well-known electrophotographic method. In the present embodiment, the image forming section 140 forms an image of the image data received from the CPU 111 on the recording medium conveyed by the sheet feed section 150. The recording medium on which the image is formed is discharged to the sheet ejection tray 159. The image data that is output by the CPU 111 to the image forming section 140 includes image data such as externally received printing data in addition to the image data received from the document reading section 130.

The main circuit 110 includes a Central Processing Unit (CPU) 111 for controlling the MFP 100 as a whole, a communication interface (I/F) unit 112, a Read Only Memory (ROM) 113, a Random Access Memory (RAM) 114, a Hard Disc Drive (HDD) 115 that is used as a mass storage device, a facsimile unit 116 and an external storage device 118. The CPU 111 is connected to the automatic document conveyance apparatus 120, the document reading section 130, the image forming section 140, the sheet feed section 150 and the operation panel 160, and controls the MFP 100 as a whole.

The ROM 113 stores a program to be executed by the CPU 111 or data required for execution of the program. The RAM 114 is used as a work area when the CPU 111 executes the program. Further, the RAM 114 temporarily stores image data successively sent from the document reading section 130.

The operation panel 160 is provided in an upper portion of the MFP 100. The operation panel 160 includes a display part 161 and an operation part 163. The display part 161 is a Liquid Crystal Display Device (LCD), for example, and displays an instruction menu for a user, information about acquired image data, etc. As long as displaying images, an organic Electroluminescence (EL) display, for example, can be used instead of the LCD.

The operation part 163 includes a touch screen 165 and a hard key part 167. The touch screen 165 is a capacitance type. The touch screen 165 is not limited to the capacitance type, and another type such as a resistive film type, a surface acoustic wave type, an infrared type and an electromagnetic induction type can be used.

The touch screen 165 is provided with its detection surface being superimposed on an upper surface or a lower surface of the display part 161. Here, the size of the detection surface of the touch screen 165 and the size of the display surface of the display part 161 are the same. Therefore, the coordinate system of the display surface and the coordinate system of the detection surface are the same. The touch screen 165 detects a position designated by the user on the display surface of the display part 161 using the detection surface, and outputs a set of coordinates of the detected position to the CPU 111. Because the coordinate system of the display surface and the coordinate system of the detection surface are the same, the set of coordinates output by the touch screen 165 can be replaced with the set of coordinates of the display surface.

The hard key part 167 includes a plurality of hard keys. The hard keys are contact switches, for example. The touch screen 165 detects a position designated by the user on the display surface of the display part 161.

The communication I/F section 112 is an interface for connecting the MFP 100 to a network. The communication I/F section 112 communicates with another computer or a data processing apparatus connected to the network using a communication protocol such as a Transmission Control Protocol (TCP) or a File Transfer Protocol (FTP). The network to which the communication I/F section 112 is connected is a Local Area Network (LAN), either wired or wireless. Further, the network is not limited to a LAN and may be a Wide Area Network (WAN), a Public Switched Telephone Network (PSTN), the Internet or the like.

The facsimile unit 116 is connected to the Public Switched Telephone Network (PSTN), transmits facsimile data to the PSTN or receives facsimile data from the PSTN. The facsimile unit 116 stores the received facsimile data in the HDD 115, converts the facsimile data into printing data that is printable in the image forming section 140 and outputs the printing data to the image forming section 140. Thus, the image forming section 140 forms an image represented by the facsimile data received from the facsimile unit 116 on a sheet. Further, the facsimile unit 116 converts the data stored in the HDD 115 into facsimile data and transmits the converted facsimile data to a facsimile machine connected to the PSTN.

The external storage device 118 is controlled by the CPU 111 and mounted with a Compact Disk Read Only Memory (CD-ROM) 118A or a semiconductor memory. While the CPU 111 executes a program stored in the ROM 113 by way of example in the present embodiment, the CPU 111 may control the external storage device 118, read a program to be executed by the CPU 111 from the CD-ROM 118A and store the read program in the RAM 114 for execution.

It is noted that a recording medium for storing a program to be executed by the CPU 111 is not limited to the CD-ROM 118A. It may be a flexible disc, a cassette tape, an optical disc (Magnetic Optical Disc (MO)/Mini Disc (MD)/Digital Versatile Disc (DVD)), an IC card, an optical card, and a semiconductor memory such as a mask ROM and an Erasable Programmable ROM (EPROM). Further, the CPU 111 may download a program from a computer connected to the network and store the program in the HDD 115, or the computer connected to the network may write the program in the HDD 115. Then, the program stored in the HDD 115 may be loaded into the RAM 114 to be executed by the CPU 111. The program referred to here includes not only a program directly executable by the CPU 111 but also a source program, a compressed program, an encrypted program and the like.

FIG. 3 is a schematic side view illustrating the inner configuration of part of an image forming section and a sheet feed section. With reference to FIG. 3, a main conveyance path 41 indicated by the thick dotted line is formed to basically extend in an up-and-down direction in the MFP 100. The main conveyance path 41 is a path for guiding a recording medium that is conveyed from the sheet feed section 150 to the sheet ejection tray 159 through the image forming section 140. In the main conveyance path 41 of the present example, a lower end portion 43 opposite to an upper end portion 13 located at a position farther upward than the image forming section 140 forms an inlet port for receiving sheets from the sheet feed section 150. Further, the upper end portion 13 of the main conveyance path 41 forms a discharge port for discharging sheets on which images have been formed to the sheet ejection tray 159. A sheet ejection roller 15 is provided at the upper end portion 13 of the main conveyance path 41. The lower end portion 43 of the main conveyance path 41 is connected to a plurality of sub-conveyance paths SP1, SP2, SP3 of the sheet feed section 150, described below.

The sheet feed section 150 includes the three sheet feed trays 151, 152, 153 and the manual sheet feed tray 154. The three sheet feed trays 151, 152, 153 are arranged in a stack in this order from above toward below. The manual sheet feed tray 154 is provided at a sidewall 101 of the MFP 100 and located at a position farther downward than the image forming section 140. As indicated by the thick one-dot and dash lines in FIG. 3, the sub-conveyance path SP1 is formed to extend from the sheet feed tray 151, which is the top tray among the three sheet feed trays 151, 152, 153, to the lower end portion 43 of the main conveyance path 41. Further, the sub-conveyance path SP2 is formed to extend from the manual sheet feed tray 154 to the lower end portion 43 of the main conveyance path 41. Further, two sub-conveyance paths 152a, 153a that respectively extend from the sheet feed trays 152, 153, which are the middle and bottom trays among the three sheet feed trays 151, 152, 153, to the lower end portion 43 of the main conveyance path 41 are formed. The portion having a predetermined length from the lower end portion 43 of the main conveyance path 41 to the point where the main conveyance path 41 branches into the two sub-conveyance paths 152a, 153a is a sub-conveyance path SP3, which is shared by the two sub-conveyance paths 152a, 153a.

A pickup roller 151p and a sheet feed roller 151r are provided to correspond to the sheet feed tray 151. The sheet feed roller 151r is provided on the sub-conveyance path SP1. A pickup roller 152p and a sheet feed roller 152r are provided to correspond to the sheet feed tray 152. The sheet feed roller 152r is provided on the sub-conveyance path 152a. A pickup roller 153p and a sheet feed roller 153r are provided to correspond to the sheet feed tray 153. The sheet feed roller 153r is provided on the sub-conveyance path 153a. A pickup roller 154p and a sheet feed roller 154r are provided to correspond to the manual sheet feed tray 154. The sheet feed roller 154r is provided on the sub-conveyance path SP2. An operation of taking out a recording medium from each of the sheet feed trays 151, 152, 153 and the manual sheet feed tray 154 and conveying the recording medium is a common operation performed with the sheet feed trays 151, 152, 153 and the manual sheet feed tray 154. Here, a recording medium is taken from the sheet feed tray 151, by way of example.

In the sheet feed tray 151, one or more recording media are stored in a stack. The sheet feed tray 151 has a lift-up mechanism that lifts the one or more recording media stored therein. The pickup roller 151p is biased downwardly by an elastic member such as a spring. Therefore, the pickup roller 151p abuts against the recording medium at the top among one or more recording media stored in the sheet feed tray 151 from above and presses the recording media from above. The pickup roller 151p rotates, so that the recording medium at the top is sent out to the sub-conveyance path SP1 by the friction force between the pickup roller 151p and the recording medium. The recording medium sent out to the sub-conveyance path SP1 is supplied to the main conveyance path 41 by the sheet feed roller 151r as a recording medium.

With the rotation of the pickup roller 151p, in a period during which the recording medium at the top among the one or more recording media stored in the sheet feed tray 151 is sent out to the sub-conveyance path SP1 due to friction between the pickup roller 151p and the recording medium, a recording medium that is the second from the top and overlaps with the recording medium at the top receives a friction force from the recording medium at the top. Therefore, the recording medium that is the second from the top may be conveyed together with the recording medium at the top. In order to prevent this, a sorting roller is arranged at a position opposite to the pickup roller 151p. The sorting roller comes into contact with the recording medium that is the second from the top. The force biasing the pickup roller 151p is adjusted such that the frictional force between the pickup roller 151p and the recording medium at the top and the frictional force between the sorting roller and the recording medium that is the second from the top are larger than the frictional force between the recording medium at the top and the recording medium that is the second from the top.

In the MFP 100, during image formation, a tray storing a recording medium on which an image is to be formed is selected from among the three sheet feed trays 151, 152, 153 and the manual sheet feed tray 154 as a subject tray. The pickup roller and the sheet feed roller corresponding to a tray selected as a subject tray from among the three sheet feed trays 151, 152, 153 and the manual sheet feed tray 154 operate, whereby a recording medium is supplied to the main conveyance path 41 through any of the sub-conveyance paths SP1, SP2, SP3 from the tray selected as a subject tray.

The image forming section 140 includes respective image forming units 21Y, 21M, 21C, 21K for respective yellow, magenta, cyan and black. At least one of the image forming units 21Y, 21M, 21C, 21K is driven, so that an image is formed on a recording medium. When all of the image forming units 21Y, 21M, 21C, 21K are driven, a full-color image is formed. Printing data pieces for yellow, magenta, cyan and black are respectively input to the image forming units 21Y, 21M, 21C, 21K. The only difference among the image forming units 21Y, 21M, 21C, 21K is the colors of toner used by the image forming units 21Y, 21M, 21C, 21K. Here, the image forming unit 21Y for forming an image in yellow will be described.

The image forming unit 141Y includes an exposure head to which printing data for yellow is input, a photosensitive drum (an image bearing member), an electric charger, a developing device and a transfer roller 23Y. The exposure head emits laser light in accordance with the received printing data (electrical signal). A polygon mirror included in the exposure head scans the emitted laser light one-dimensionally to expose the photosensitive drum. The direction in which the laser light one-dimensionally scans the photosensitive drum is a main scanning direction. After being electrically charged by the electric charger, the photosensitive drum is irradiated with the laser light emitted by the exposure head. Thus, an electrostatic latent image is formed on the photosensitive drum. Subsequently, toner is applied onto the electrostatic latent image by the developing device, and a toner image is formed. The toner image formed on the photosensitive drum is transferred onto an intermediate transfer belt 27 by the transfer roller 143Y.

On the other hand, the intermediate transfer belt 27 is suspended by a driving roller 24 and a roller 24A not to loosen. When the driving roller 24 is rotated counterclockwise in the diagram, the intermediate transfer belt 27 is rotated counterclockwise in the diagram at a predetermined speed. The roller 24A is rotated counterclockwise due to the rotation of the intermediate transfer belt 27.

Thus, the image forming units 21Y, 21M, 21C, 21K sequentially transfer toner images onto the intermediate transfer belt 27. Timing for transferring toner images onto the intermediate transfer belt 27 by the respective image forming units 21Y, 21M, 21C, 21K is adjusted by detection of a reference mark provided on the intermediate transfer belt 27. Thus, toner images in yellow, magenta, cyan and black are superimposed on the intermediate transfer belt 27.

In the main conveyance path 41, a timing roller 45, a transfer roller 47 and a fixing roller 49 are arranged in this order at intervals from the lower end portion 43 to the upper end portion 13. A recording medium that has been supplied from the sheet feed section 150 to the main conveyance path 41 is sent to the timing roller 45.

The timing roller 45 adjusts the conveyance state of the recording medium in the main conveyance path 41 such that the recording medium arrives at the transfer roller 47 at a point in time at which a toner image formed on the intermediate transfer belt 27 arrives at the transfer roller 47. The recording medium conveyed by the timing roller 45 is pressed against the intermediate transfer belt 27 by the transfer roller 47, and the transfer roller 47 is electrically charged. Thus, yellow, magenta, cyan and black toner images that are formed on the intermediate transfer belt 27 in a superimposed manner are transferred to the recording medium. A voltage to be applied to the transfer roller 47 is controlled by the CPU 111, so that the charge amount of the transfer roller 47 is adjusted to a value suitable for the basis weight of the recording medium.

The recording medium to which the toner image has been transferred is conveyed to the fixing roller 49 and heated by the fixing roller 49. Thus, the toner is fused and fixed to the recording medium. Thereafter, the recording medium on which an image has been formed is discharged onto the sheet ejection tray 159 from the upper end portion 13 of the main conveyance path 41 by the sheet ejection roller 15. The temperature of the fixing roller 49 is controlled by the CPU 111 to be the value suitable for the basis weight of the recording medium.

In the MFP 100 in the present embodiment, an ultrasonic sensor 29 and an optical sensor 30 having detection areas in the main conveyance path 41 are provided.

The optical sensor 30 includes a light emitter 60a and a light receiver 60b and is transmissive. The optical sensor 30 is arranged at a position farther upstream than the ultrasonic sensor 29 between the lower end portion 43 of the main conveyance path 41 and the timing roller 45. The optical sensor 30 is arranged such that the light emitter 30a and the light receiver 30b are opposite to each other with the main conveyance path 41 provided therebetween. The optical sensor 30 detects a recording medium in the area in the main conveyance path 41 between the light emitter 30a and the light receiver 30b. The optical sensor 30 outputs a transmittance indicating the ratio of an amount of light received by the light receiver 30b to an amount of light emitted by the light emitter 30a. While a transmissive optical sensor is illustrated as the optical sensor by way of example, the optical sensor may be a reflective optical sensor. Further, a transmissive optical sensor and a reflective optical sensor may be combined. A basis weight can be detected by the optical sensor 30.

The ultrasonic sensor 29 includes an ultrasonic wave emitter 29a and an ultrasonic wave receiver 2 9b and is a transmissive type. The ultrasonic sensor 29 is arranged at a position farther downstream than the optical sensor 30 between the lower end portion 43 of the main conveyance path 41 and the timing roller 45. In the ultrasonic sensor 29, an ultrasonic wave emitter 29a and an ultrasonic wave receiver 29b are arranged to be opposite to each other with the main conveyance path 41 provided therebetween. The ultrasonic wave emitter 29a includes a piezoelectric element, a drive circuit of the piezoelectric element and emits an ultrasonic wave. The ultrasonic wave receiver 29b includes a piezoelectric element and a detection circuit for detecting an electromotive force generated in the piezoelectric element, and detects an electromotive force generated in the piezoelectric element by an ultrasonic wave emitted from the ultrasonic wave emitter 29a. The area in the main conveyance path 41 between the ultrasonic wave emitter 29a and the ultrasonic wave receiver 29b is the detection area.

The ultrasonic sensor 29 causes the ultrasonic wave emitter 29a to emit an ultrasonic wave having a predetermined volume to the detection area. A recording medium travels to cross the detection area with the ultrasonic wave emitter 29a emitting an ultrasonic wave to the detection area, whereby the ultrasonic wave hits a portion of the traveling recording medium. At this time, part of the ultrasonic wave that has hit the recording medium is transmitted through the recording medium, and the rest of the ultrasonic wave is absorbed by the recording medium or reflected from the recording medium. The ultrasonic wave receiver 29b receives the ultrasonic wave that has been transmitted through the recording medium, and outputs a signal corresponding to the volume of the received ultrasonic wave to the CPU 111. Here, the ultrasonic sensor 29 outputs a value indicating the attenuation amount of the ultrasonic wave. Here, the value indicating the attenuation amount of an ultrasonic wave is referred to as an attenuation rate. An attenuation rate indicates the ratio of the volume of an ultrasonic wave that is transmitted through a recording medium with respect to the volume of an emitted ultrasonic wave. Further, a value indicating the attenuation amount of an ultrasonic wave may be a value obtained by subtraction of the volume of a received ultrasonic wave from the volume of an emitted ultrasonic wave.

An attenuation rate of an ultrasonic wave differs depending on the basis amount of a sheet, and there is a predetermined relationship between the attenuation rate of an ultrasonic wave and the basis weight of a sheet. The larger the basis weight of a sheet, the larger the attenuation rate of an ultrasonic wave. Therefore, the relationship between the basis weight of a sheet and the attenuation rate of an ultrasonic wave is obtained by an experiment or the like in advance, so that the basis amount of a sheet is determined based on the attenuation rate of an ultrasonic wave.

The attenuation rate of an ultrasonic wave in regard to a sheet and the attenuation rate of an ultrasonic wave in regard to an overlay sheet are significantly different from each other. This is because two sheets are overlaid on each other in an overlay sheet. When two sheets are overlaid on each other, a gap is present between the two sheets. Therefore, the attenuation rate of an ultrasonic wave in regard to an overlay sheet is significantly small as compared to the attenuation rate of an ultrasonic wave in regard to one sheet. The attenuation rate of two sheets that are overlaid on each other and has the smallest basis weight is smaller than the attenuation rate of a sheet having the largest basis weight. Therefore, presence or absence of a gap can be detected based on the attenuation rate of an ultrasonic wave.

Further, presence or absence of a recording medium may be detected based on the attenuation rate of an ultrasonic wave. Therefore, based on an output value of the ultrasonic sensor 29, the position of a recording medium may be detected. In this manner, the ultrasonic sensor 29 can function as a position detection sensor that detects the position of a recording medium.

It is possible to not only determine the type of a recording medium but also detect the type and the basis weight of the recording medium at the same time by combining the optical sensor 30 with the ultrasonic sensor 29. This improves convenience. In a case in which the type of a recording medium is stored in the RAM 114, the optical sensor 30 may be used as a timing sensor for detecting presence or absence of a sheet. Further, detection of a basis weight by the optical sensor 30 and detection of an overlay state by the ultrasonic sensor 29 can be executed in parallel.

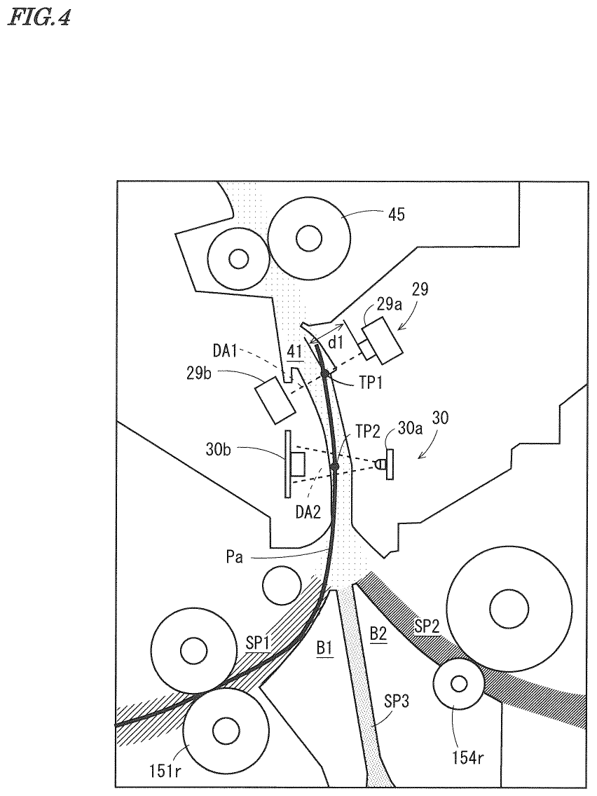

FIG. 4 is a side view illustrating the detection area in the conveyance path. In FIG. 4, two types of different hatching patterns are applied to the sub-conveyance paths SP1, SP2, and two types of different dotted patterns are applied to the main conveyance path 41 and the sub-conveyance path SP3 in order to facilitate understanding of the shapes of the main conveyance path 41 and the plurality of sub-conveyance paths SP1, SP2, SP3, and their positional relationship. Further, a portion of a recording medium Pa that travels through the main conveyance path 41 is illustrated. Here, single feed of the recording medium Pa is illustrated, by way of example.

As indicated by the dotted line in FIG. 4, the ultrasonic sensor 29 is arranged to have a detection area DA1 in the main conveyance path 41. The detection area DA1 of the ultrasonic sensor 29 extends in the direction that intersects with the direction in which the recording medium Pa travels and intersects with the recording medium Pa traveling through the main conveyance path 41. In the detection area DA1, a target position TP1 is set at a position that is spaced apart from the ultrasonic wave emitter 29a by a predetermined distance and is on the line that connects the ultrasonic wave emitter 29a to the ultrasonic wave receiver 29b. The target position TP1 is an ideal position through which the recording medium Pa that travels through the main conveyance path 41 is to pass in the detection area DA1 for detection of an attenuation rate.

The optical sensor 30 is arranged to have a detection area DA2 in the main conveyance path 41. The detection area DA2 of the optical sensor 30 extends in the direction that intersects with the direction in which the recording medium Pa travels and intersects with the recording medium Pa traveling through the main conveyance path 41. In the detection area DA2, a target position TP2 is set at a position that is spaced apart from the light emitter 30a by a predetermined distance and is on the line that connects the light emitter 30a to the light receiver 30b. The target position TP2 is an ideal position through which the recording medium Pa that travels through the main conveyance path 41 is to pass in the detection area DA2 for detection of a transmittance.

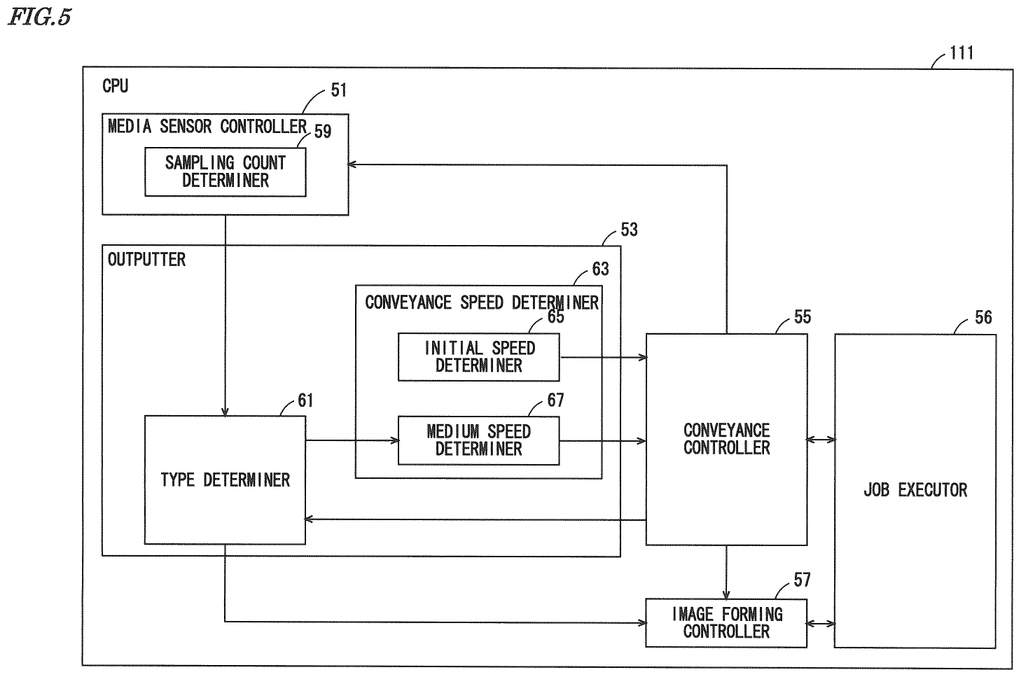

FIG. 5 is a diagram illustrating one example of the functions of a CPU of the MFP in the present embodiment. The functions illustrated in FIG. 5 are implemented by the CPU 111 included in the MFP 100 when the CPU 111 executes a conveyance control program stored in the ROM 113, the HDD 115 or the CD-ROM 118A. With reference to FIG. 5, the CPU 111 includes a medium sensor controller 51, an outputter 53, a conveyance controller 55, a job executor 56 and an image forming controller 57.

The medium sensor controller 51 controls the ultrasonic sensor 29 and the optical sensor 30. The medium sensor controller 51 controls the ultrasonic sensor 29 to acquire an attenuation rate output by the ultrasonic sensor 29 in a period during which a recording medium passes through the detection area DA1. The medium sensor controller 51 controls the optical sensor 30 and acquires a transmittance output by the optical sensor 30 in a period during which a recording medium passes through the detection area DA2. The medium sensor controller 51 outputs the attenuation rate and the transmittance to the outputter 53.

The outputter 53 receives the attenuation rate and the transmittance from the medium sensor controller 51. The outputter 53 determines a conveyance speed based on the attenuation rate and the transmittance, and outputs the determined conveyance speed to the conveyance controller 55. The outputter 53 includes a type determiner 61 and a conveyance speed determiner 63.

The type determiner 61 determines the type of a recording medium based on the transmittance and the attenuation rate received from the medium sensor controller 51, and outputs the determined type of a recording medium to the conveyance speed determiner 63. The type of a recording medium includes a sheet and an overlay sheet. Further, a sheet is a plain paper, a wood free paper, a recycled paper or a photo paper. An overlay paper indicates two or more sheets being superimposed on one another, and is an envelope, for example. The attenuation rates of a sheet and an overlay sheet are respectively obtained by an experiment in advance, and a threshold value is determined. The type determiner 61 determines whether the type of a recording medium is a sheet or an overlay sheet by comparing the attenuation rate of an ultrasonic wave received from the medium sensor controller 51 with the threshold value. Specifically, if the attenuation rate of an ultrasonic wave received from the medium sensor controller 51 is equal to or smaller than the threshold value, the type determiner 61 determines that the type of a recording medium is an overlay sheet. If the attenuation rate of an ultrasonic wave received from the medium sensor controller 51 is larger than the threshold value, the type determiner 61 determines that the type of a recording medium is a sheet.

Further, in a case in which determining that the type of a recording medium is a sheet, the type determiner 61 detects the basis weight of the recording medium based on a transmittance. The type determiner 61 obtains the relationship between an attenuation rate and a basis weight in advance by an experiment or simulation and maintains the obtained relationship, thereby determining a basis weight based on the relationship and a transmittance. In the present embodiment, a table or an arithmetic expression that associates a transmittance to a basis weight is stored in the HDD 115. Further, by making reference to the table defining the relationship between the type and the basis weight of a recording medium, the type determiner 61 determines the type of a recording medium based on the determined basis weight. The type determiner 61 outputs the type of a recording medium to the conveyance controller 55, and outputs the basis weight to the image forming controller 57.

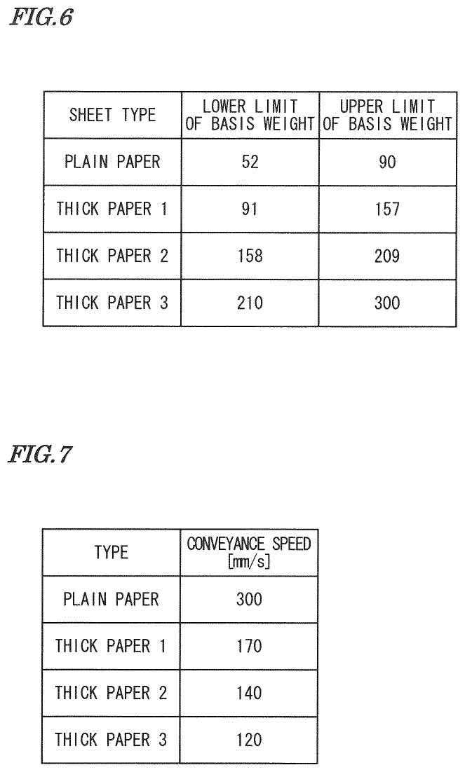

FIG. 6 is a diagram illustrating one example of a type table. With reference to FIG. 6, the type table includes an item for a type, an item for the lower limit of a basis weight and an item for the upper limit of a basis weight, and associates the types of a recording medium with basis weights. In the item for a type, the type of a recording medium is set. In the item for the lower limit for a basis weight, the lowest value of the basis weight of a recording medium the type of which is set in the item for a type is set. In the item for the upper limit of a basis weight, the highest value of the basis weight of a recording medium the type of which is set in the item for a type is set.

A type record defines the lower limit value and the upper limit value of the basis weight of a recording medium in regard to each of a plain paper, a thick paper 1, a thick paper 2 and a thick paper 3. The plain paper has the smallest basis weight, the thick paper 1 has the second smallest basis weight, the thick paper 2 has the third smallest basis weight, and the thick paper 3 has the largest basis weight. In regard to the basis weight of a recording medium the type of which is the “PLAIN PAPER,” the lower limit value and the upper limit value are respectively set to 52 g/m² and 90 g/m². In regard to the basis weight of a recording medium the type of which is the “THICK PAPER 1,” the lower limit value and the upper limit value are respectively set to 91 g/m² and 157 g/m². In regard to the basis weight of a recording medium the type of which is the “THICK PAPER 2,” the lower limit value and the upper limit value are respectively set to 158 g/m² and 209 g/m². In regard to the basis weight of a recording medium the type of which is the “THICK PAPER 3,” the lower limit value and the upper limit value are respectively set to 210 g/m² and 300 g/m².

Referring back to FIG. 5, the conveyance speed determiner 63 receives the type of a recording medium from the type determiner 61. The conveyance speed determiner 63 determines the conveyance speed of a recording medium based on the type of a recording medium. The conveyance speed of a recording medium is determined in advance for the type of a recording medium. In the present embodiment, a speed table in which a conveyance speed is associated with each of a plurality of types of recording media is stored in the HDD 115. With reference to the speed table, the conveyance speed determiner 63 determines a conveyance speed corresponding to the type of a recording medium. The conveyance speed determiner 63 includes an initial speed determiner 65 and a medium speed determiner 67.

FIG. 7 is a diagram illustrating one example of a speed table. With reference to FIG. 7, the speed table includes a speed record including an item for a type and an item for a conveyance speed, and associates a type and a conveyance speed of a recording medium with each other. In the item for a type, the type of a recording medium is set. In the item for a conveyance speed, the conveyance speed of a recording medium is set. A speed record defines the conveyance speed of a recording medium in regard to each of the plain paper, the thick paper 1, the thick paper 2 and the thick paper 3. The plain paper has the highest conveyance speed, the thick paper 1 has the second highest conveyance speed, the thick paper 2 has the third highest conveyance speed, and the thick paper 3 has the lowest conveyance speed. In regard to a recording medium the type of which is the “PLAIN PAPER,” the conveyance speed is set to 300 mm/s. In regard to a recording medium the type of which is the “THICK PAPER 1,” the conveyance speed is set to 170 mm/s. In regard to a recording medium the type of which is the “THICK PAPER 2,” the conveyance speed is set to 140 mm/s. In regard to a recording medium the type of which is the “THICK PAPER 3,” the conveyance speed is set to 120 mm/s.

Reference back to FIG. 5, the initial speed determiner 65 determines a first speed as a conveyance speed, and outputs a value of the first speed to the conveyance controller 55. Here, as the first speed, the minimum value of a conveyance speed determined for each of a plurality of types of recording media is used. The initial speed determiner 65 determines the first speed as a conveyance speed at a predetermined point in time. The predetermined point in time includes a first point in time after MFP 100 is powered on, a second point in time after detection of an opening and closing of a tray that supplies a recording medium among the sheet feed trays 151, 152, 153, and a third point in time after a print job, in regard to which the transmittance and the attenuation rate that are output by the medium sensor controller 51 after determination of the type of a recording medium by the type determiner 61 are changed by a value equal to or larger than a predetermined value from the determined transmittance and the determined attenuation rate corresponding to the type of a recording medium is completed.

Based on a transmittance and an attenuation rate detected by the medium sensor controller 51 in regard to a recording medium conveyed at a conveyance speed that is determined as the first speed by the initial speed determiner 65, the type of a recording medium is determined by the type determiner 61. The medium speed determiner 67 determines a conveyance speed based on the type of a recording medium determined by the type determiner 61 in regard to a recording medium conveyed at a conveyance speed that is determined as the first speed.

The job executor 56 executes a print job and generates printing data to be used to form an image by the image forming section 140. A print job defines a process of forming images on a plurality of recording media. When executing a print job, the job executor 56 generates printing data based on data subject to image formation in accordance with print conditions. For example, in a case in which the communication I/F section 112 receives a print job from an external computer, the image forming controller 57 executes the print job. A print job is written in Printer Job Language (PJL) or Printer Control Language (PCL), for example, and includes print conditions and data subject to image formation. Further, in a case in which a user operates the operation part 163, the job executor 56 executes a job designated by the user. A job designated by the user includes print conditions and data subject to image formation. The data subject to image formation is the data designated by the user. The data designated by the user includes image data output by the document reading section 130 that has read a document, data stored in the HDD 115 and data stored in an external computer.

Printing data is bitmap data, for example. Printing data corresponds to the size of a sheet on which an image is to be formed and defines an image to be formed on a sheet using a plurality of pixel values. Printing data includes four data pieces respectively corresponding to yellow, magenta, cyan and black. Therefore, in a case in which having a plurality of pages, printing data includes four data pieces respectively corresponding to yellow, magenta, cyan and black for each of the plurality of pages.

The job executor 56 outputs print conditions to the conveyance controller 55 and the image forming controller 57, and outputs printing data to the image forming controller 57. The image forming controller 57 controls the image forming section 140 to form an image of printing data according to print conditions. The image forming controller 57 receives the basis weight of a recording medium from the type determiner 61. Based on printing data and a basis weight, the conveyance controller 55 controls the image forming section 140 such that the transfer roller 47 is electrically charged to an electric potential that is suitable for transferring a toner image formed on the intermediate transfer belt 27 to a recording medium on which an image is to be formed. Further, the image forming controller 57 determines an image forming condition based on a basis weight and forms an image according to the image forming condition. For example, in a case in which the basis weight of a recording medium is large, the charge amount of the transfer roller 47 is set higher, and the temperature of the fixing roller 49 is set higher. On the other hand, in a case in which the basis weight of a recording medium is small, the charge amount of the transfer roller 47 is set lower, and the temperature of the fixing roller 49 is set lower.

The conveyance controller 55 controls the sheet feed section 150 and conveys a sheet stored in any of the three sheet feed trays 151, 152, 153 and the manual sheet feed tray 154 as a recording medium. The conveyance controller 55 selects, as a subject tray, a tray defined according to print conditions from among the three sheet feed trays 151, 152, 153 and the manual sheet feed tray 154. The conveyance controller 55 controls a pickup roller and a sheet feed roller for supplying a sheet to the image forming section 140 from a subject tray. For example, the conveyance controller 55 rotates the pickup roller 151p and the sheet feed roller 151r in a case in which the sheet feed tray 151 is selected as a subject tray. Further, the conveyance controller 55 rotates the pickup roller 152p and the sheet feed roller 152r in a case in which the sheet feed tray 152 is selected as a subject tray. Further, the conveyance controller 55 rotates the pickup roller 153p and the sheet feed roller 153r in a case in which the sheet feed tray 153 is selected as a subject tray. Further, the conveyance controller 55 rotates the pickup roller 154p and the sheet feed roller 154r in a case in which the manual sheet feed tray 154 is selected as a subject tray. With this control, a recording medium is conveyed from any of the sheet feed trays 151, 152, 153 and the manual sheet feed tray 154 to the main conveyance path 41.

The conveyance controller 55 receives a conveyance speed from the outputter 53. The conveyance controller 55 controls the sheet feed section 150 to convey a recording medium. The conveyance controller 55 outputs a conveyance speed at which a recording medium is conveyed to the image forming controller 57. In a case in which receiving print conditions for formation of images for a plurality of pages from the image forming controller 57, the conveyance controller 55 successively conveys a plurality of recording media. The conveyance controller 55 conveys a recording medium which is conveyed firstly among recording media having the number of sheets to be printed, with the number being defined by print conditions, at the first speed. In the present embodiment, the first speed is a conveyance speed received from the initial speed determiner 65.

The conveyance controller 55 receives a conveyance speed from the medium speed determiner 67 in a period during which the recording medium being conveyed firstly is conveyed. A conveyance speed received from the medium speed determiner 67 in a period during which the recording medium being conveyed firstly is conveyed is determined based on an attenuation rate and a transmittance acquired, by the medium sensor controller 51, for the recording medium being conveyed firstly. In a case in which a conveyance speed received from the medium speed determiner 67 in a period during which the recording medium being conveyed firstly is conveyed is a second speed that is different from the first speed, the conveyance controller 55 conveys, at the second speed, the recording medium being conveyed firstly. The second speed is a conveyance speed received from the medium speed determiner 67, and is a speed different from an initial value. Thus, the second speed is higher than the first speed. The conveyance controller 55 conveys the recording medium being conveyed secondly and subsequently among recording media having the number of sheets to be printed, with the number being defined by print conditions, at the second speed. Further, even in a case in which a conveyance speed received from the medium speed determiner 67 in a period during which the recording media being conveyed secondly and subsequently among the recording media having the number of sheets to be printed, with the number being defined by print conditions, are conveyed is different from the second speed, the conveyance controller 55 conveys the recording media being conveyed secondly and subsequently at the second speed.

The conveyance controller 55 controls the rotation speeds of the pickup roller, the sheet feed roller, the timing roller 45, the transfer roller 47, the fixing roller 49 and the sheet ejection roller 15 of the sheet feed section 150 to adjust the conveyance speed of a recording medium.

The medium sensor controller 51 includes a sampling count determiner 59. A sampling count of the ultrasonic sensor 29 is the number of times the ultrasonic sensor 29 emits and detects an ultrasonic wave in order to output an attenuation rate. The larger the sampling count, the larger the power consumed by the ultrasonic sensor 29. However, the larger the sampling count, the more accurate an attenuation rate output by the ultrasonic sensor 29. Conversely, the smaller the sampling count, the smaller the power consumed by the ultrasonic sensor 29. However, the smaller the sampling count, the less accurate an attenuation rate output by the ultrasonic sensor 29. The sampling count of the optical sensor 30 is the number of times the optical sensor 30 emits and receives light in order to output a transmittance. The larger the sampling count, the larger the power consumed by the optical sensor 30. However, the larger the sampling count, the more accurate a transmittance output by the optical sensor 30. Conversely, the smaller the sampling count, the smaller the power consumed by the optical sensor 30. However, the smaller the sampling count, the less accurate an attenuation rate output by the optical sensor 30. In a case in which the recording medium being conveyed firstly among recording media having the number of sheets to be printed, with the number being defined by print conditions, is conveyed by the conveyance controller 55, the sampling count determiner 59 determines a normal count as a sampling count. In a case in which the recording media being conveyed secondly and subsequently are conveyed, the sampling count determiner 59 determines a count smaller than the normal count as a sampling count.

The type determiner 61 receives an attenuation rate and a transmittance from the medium sensor controller 51 in regard to each of recording media the number of which is equal to the number of sheets to be printed, with the number of sheets being defined by print conditions. The type determiner 61 determines a type in regard to each of recording media the number of which is equal to the number of sheets to be printed, with the number of sheets being defined by print conditions, outputs a basis weight to the image forming controller 57 and outputs the type of a recording medium to the medium speed determiner 67.

Among recording media the number of which is equal to the number of sheets to be printed, with the number of sheets being defined by print conditions, the type determiner 61 may determine the type of the recording medium being conveyed firstly and the type of any one of the subsequent recording media being conveyed secondly and subsequently. In this case, the type determiner 61 is simply required to determine the types of the two recording media, so that a load is reduced. Further, in this case, the medium sensor controller 51 is only required to detect the attenuation rate and the transmittance for each of the recording medium being conveyed firstly and any one of the recording media being conveyed secondly and subsequently. Therefore, the power consumption of the optical sensor 30 and the ultrasonic sensor 29 can be reduced.

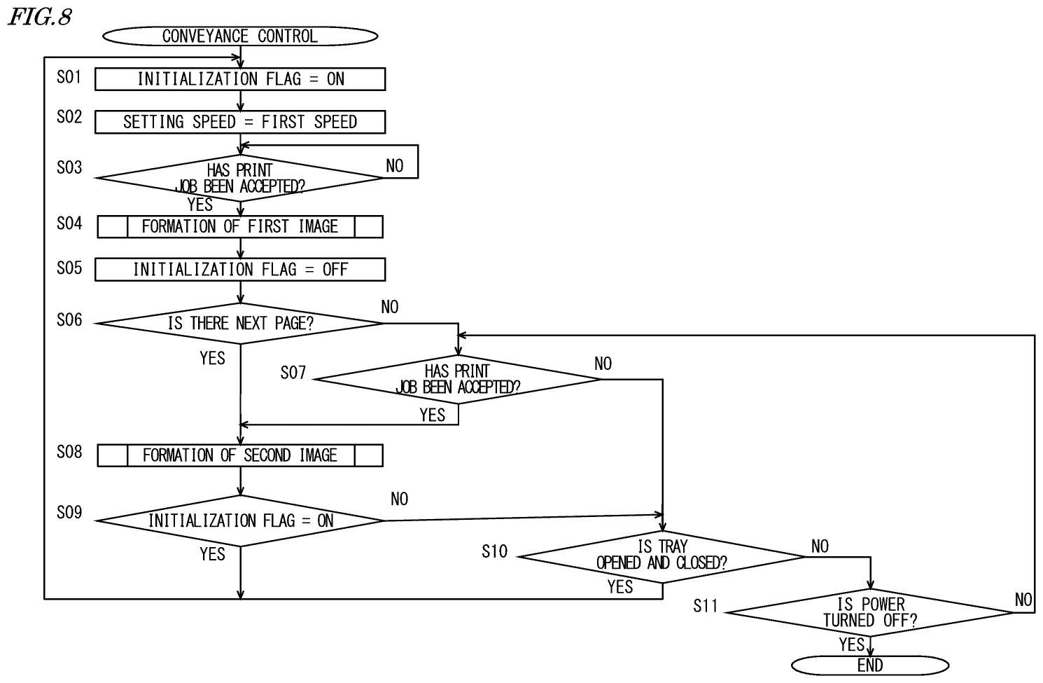

FIG. 8 is a flowchart illustrating one example of a flow of a conveyance control process. The conveyance control process is a process executed by the CPU 111 included in the MFP 100 when the CPU 111 executes the conveyance control program. With reference to FIG. 8, the CPU 111 included in the MFP 100 sets an initialization flag to ON (step S01), and the process proceeds to the step S02. In the next step S02, the setting speed is set to the first speed, and the process proceeds to the step S02. A setting speed is a conveyance speed at which the sheet feed section 150 conveys a recording medium. Therefore, the sheet feed section 150 conveys a recording medium at a setting speed. The first speed is a predetermined value as an initial value. Here, the first speed is the minimum value for a conveyance speed determined for each of a plurality of types of recording media.

In the step S03, whether a print job has been accepted is determined. The process waits until a print job is accepted (NO in the step S03). If a print job is accepted (YES in the step S03), the process proceeds to the step S04. In the step S04, a first image forming process is executed, and the process proceeds to the step S04.

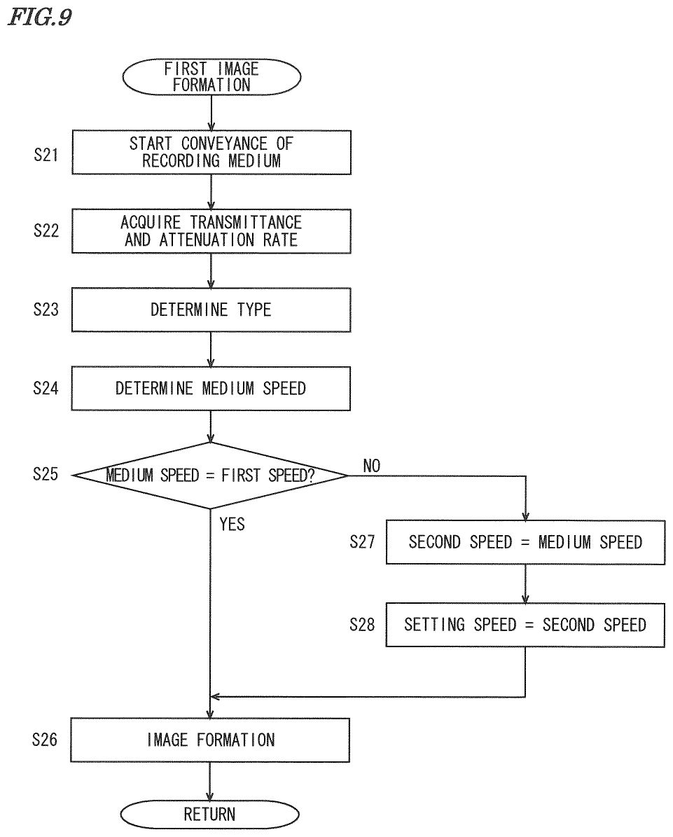

FIG. 9 is a flowchart illustrating one example of a flow of a first image forming process. With reference to FIG. 9, the CPU 111 starts conveyance of a recording medium (step S21), and the process proceeds to the step S22. In this case, because the setting speed is set to the first speed, the recording medium is conveyed at the first speed. Further, the conveyance path through which the sheet feed section 150 conveys the recording medium at the first speed is the path from any one of the sheet feed trays 151, 152, 153 and the manual sheet feed tray 154 to the timing roller 45.

In the step S22, a transmittance and an attenuation rate are acquired, and the process proceeds to the step S23. The CPU 111 controls the ultrasonic sensor 29 to acquire the attenuation rate of an ultrasonic wave transmitted through the recording medium, and controls the optical sensor 30 to acquire the transmittance of the light transmitted through the recording medium. Further, the ultrasonic sensor 29 outputs the attenuation rate measured by the normal sampling count, and the optical sensor 30 outputs the transmittance measured by the normal sampling count.

In the step S23, the type of the recording medium is determined, and the process proceeds to the step S24. Whether the recording medium is an envelope or a sheet is determined based on the attenuation rate. Further, the basis weight of the recording medium is determined based on the transmittance, and the type corresponding to the basis weight is determined.

In the step S24, a medium speed is determined, and the process proceeds to the step S25. A medium speed is a predetermined conveyance speed of a recording medium for the type of a sheet. In the step S25, whether the medium speed is equal to the first speed is determined. If the medium speed is equal to the first speed, the process proceeds to the step S26. If not, the process proceeds to the step S27.

In the step S27, the medium speed is set to the second speed, and the process proceeds to the step S28. In the step S28, the setting speed is set to the second speed, and the process proceeds to step S26.

In the step S26, an image is formed on the recording medium, and the process returns to the conveyance control process. In a case in which the process proceeds from the step S25, the setting speed is the first speed. In this case, an image is formed by the image forming section 140 while the recording medium is conveyed at the first speed. In a case in which the process proceeds from the step S28, the setting speed is the second speed. In this case, an image is formed by the image forming section 140 while the recording medium is conveyed at the second speed.

Referring back to FIG. 8, when the first image forming process ends in the step S04, the process proceeds to the step S05. In the step S05, the initialization flag is set to OFF, and the process proceeds to the step S06. In the step S06, whether there is a page subject to image formation next is determined. If there is a page subject to image formation next, the process proceeds to the step S08. If not, the process proceeds to the step S07. In the step S07, whether a print job has been accepted is determined. If the print job has been accepted, the process proceeds to the step S08. If not, the process proceeds to the step S10. In a case in which the process proceeds to the step S08, the conveyance speed is set to the second speed. In the step S08, a second image forming process is executed, and the process proceeds to the step S09.

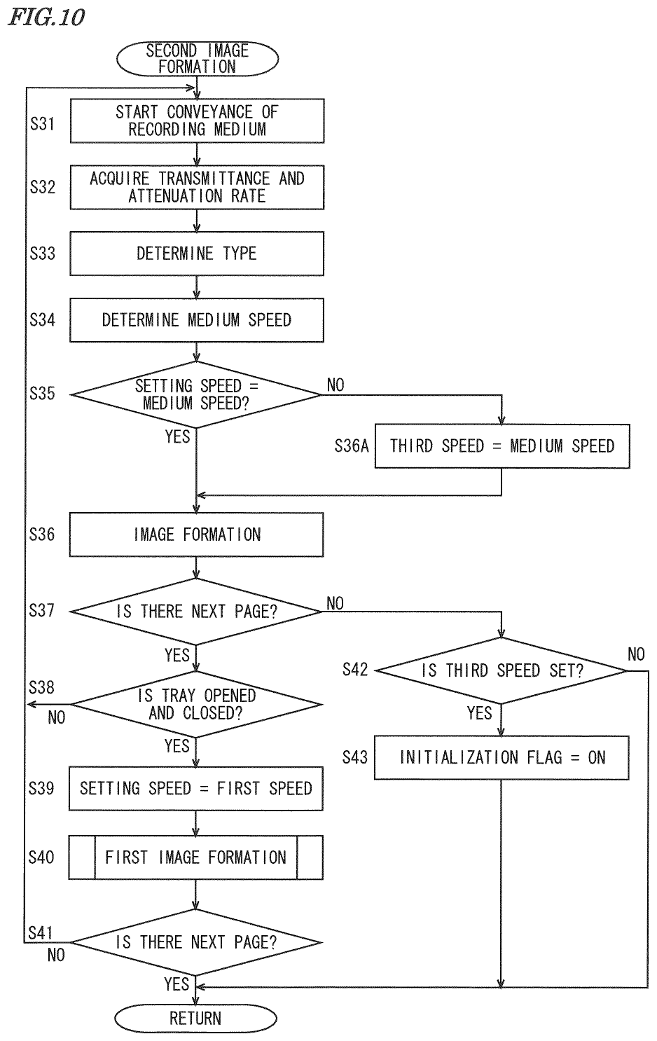

FIG. 10 is a flowchart illustrating one example of a flow of a second image forming process. With reference to FIG. 10, conveyance of a recording medium is started (step S31). Before the second image forming process is executed, the first image forming process is executed, and the setting speed is set to the second speed. Therefore, the recording medium is conveyed at the second speed.

In the step S32, a transmittance and an attenuation rate are acquired, and the process proceeds to the step S33. The CPU 111 controls the ultrasonic sensor 29 to acquire the attenuation rate of an ultrasonic wave transmitted through the recording medium, and controls the optical sensor 30 to acquire the transmittance of the light transmitted through the recording medium. Further, the ultrasonic sensor 29 outputs the attenuation rate measured by a sampling count that is smaller than a normal count, and the optical sensor 30 outputs the transmittance measured by a sampling count that is smaller than a normal count.

In the step S33, the type of the recording medium is determined, and the process proceeds to the step S34. Whether the recording medium is an envelope or a sheet is determined based on the attenuation rate. Further, the basis weight of the recording medium is determined based on the transmittance, and the type corresponding to the basis weight is determined.

In the step S34, a medium speed is determined, and the process proceeds to the step S35. A medium speed is a predetermined conveyance speed of a recording medium for the type of a sheet. In the step S35, the setting speed is compared to the medium speed. If the setting speed is equal to the medium speed, the process proceeds to the step S36. If not, the process proceeds to the step S36A. Because the setting speed is set to the second speed when the step S35 is performed, the process proceeds to the step S36A in a case in which the medium speed is different from the second speed. In the step S36A, the medium speed is set to the third speed, and the process proceeds to the step S36. In a case in which the setting speed that is set to the second speed is different from the medium speed, the setting speed is not changed, and the medium speed is set to the third speed. Therefore, the recording medium is thereafter conveyed at the second speed set as the setting speed. Therefore, even in a case in which the third speed is selected during a print job, the recording medium is conveyed at the second speed until the print job is completed.

In the step S36, an image is formed on the recording medium, and the process proceeds to step S37. In a case in which the process proceeds from either the step S35 or the S37, the setting speed is the second speed. Therefore, an image is formed by the image forming section 140 while the recording medium is conveyed at the second speed. In a case in which the process proceeds from the step S37, the conveyance speed corresponding to the type of the recording medium determined in the step S33 is different from the second speed. In regard to the setting values for formation of an image on the recording medium by the image forming section 140 in this case, the values corresponding to the type of the recording medium determined in the step S33 are used. Specifically, a voltage to be applied to the transfer roller 47 is adjusted to the value suitable for the basis weight of the recording medium, and the temperature of the fixing roller 49 is adjusted to a value suitable for the basis weight of the recording medium.

In the step S37, whether there is a page subject to image formation next is determined. If there is a page subject to image formation next, the process proceeds to the step S38. If not, the process proceeds to the step S42. In the step S38, whether the sheet feed tray has been opened and closed is determined. It is determined whether, among the sheet feed trays 151, 152, 153 and the manual sheet feed tray 154, opening and closing of the tray in which the previously conveyed recording medium has been stored is detected. If opening and closing of the tray is detected, the process proceeds to the step S39. If not, the process returns to the step S31. In a case in which the process returns to the step S31, the setting speed is the second speed. Therefore, after the step S31, while the next recording medium is conveyed at the second speed (step S31), an image for the next page is formed on the recording medium (step S36).

In the step S39, the setting speed is set to the first speed, and the process proceeds to the step S40. In the step S40, the first image forming process is executed. In the first image forming process, the recording media is conveyed at the first speed (step S21), the medium speed corresponding to the type of the recording medium is determined (step S24). In a case in which the medium speed is different from the first speed, the setting speed is set to the second speed which is the medium speed (step S28).

In the step S41, whether there is a page subject to image formation next is determined. If there is a page subject to image formation next, the process proceeds to the step S31. If not, the process proceeds to the conveyance control process. In a case in which the process returns to either the step S31 or the conveyance control process, the setting speed is the second speed. In a case in which the process returns to the step S31, after the step S31, an image for the next page is formed on the recording medium (step S36) while the next recording medium is conveyed at the second speed (step S31).

The process proceeds to the step S42 in a case in which formation of images for a plurality of pages defined by the print job on recording media is completed. In a case in which the step S37 is performed during a period in which the print job is executed, the medium speed is set to the third speed. In a case in which the step S37 is not performed during a period in which the print job is executed, a value is not set for the third speed. In the step S42, whether a value is set for the third speed is determined. If a value is set for the third speed, the process proceeds to the step S43. If not, the process returns to the conveyance control process. In the step S43, the initialization flag is set to ON, and the process returns to the conveyance control process. The initialization flag is set to ON is a case in which a value is set for the third speed, and the type of the recording medium may be changed during execution of the job.

Referring back to FIG. 8, when the second image forming process ends in the step S08, the process proceeds to the step S09. In the step S09, whether the initialization flag is set to ON is determined. If the initialization flag is set to ON, the process returns to the step S01. If not, the process proceeds to the step S10. In a case in which the initialization flag is set to ON, the type of recording medium may be changed during execution of the job. Therefore, the process returns to the step S01, the setting speed is set to the first speed (step S01), and the first image forming process is executed (step S04). Due to execution of the first image forming process, the type of the recording medium is detected, and the conveyance speed is set to the second speed. In a case in which the initialization flag is not set to ON, the process proceeds to the step S10 with the conveyance speed set to the second speed.

In a case in which the print job is not accepted in the step S07, or in a case in which the initialization flag is not set to ON in the step S09, the process advances to the step S10. In the step S10, whether the sheet feed tray has been opened and closed is determined. It is determined whether, among the sheet feed trays 151, 152, 153 and the manual sheet feed tray 154, opening and closing of the tray in which the previously conveyed recording medium has been stored is detected. If opening and closing of the tray is detected, the process returns to the step S01. If not, the process proceeds to the step S11. In a case in which the sheet feed tray is opened and closed, the sheet feed tray may be replenished with sheets. Therefore, the process returns to the step S01, the setting speed is set to the first speed (step S01), and the first image forming process is executed (step S04). Due to execution of the first image forming process, the type of the recording medium is detected, and the conveyance speed is set to the second speed. In a case in which the sheet feed tray is not opened and closed, the process proceeds to the step S11 with the conveyance speed set to the second speed.

In the step S11, whether the main power supply of the MFP 100 has been switched OFF is determined. When it is detected that the power supply is switched to OFF, the process ends. If not, the process returns to the step S07. In the step S07, whether the print job has been accepted is determined. If the print job has been accepted, the process proceeds to the step S08. In a case in which the process proceeds from the step S07 to the step S08 and the second image forming process is executed, because the conveyance speed is set to the second speed, a recording medium on which an image for the first page of the print job is to be formed is conveyed at the second speed (step S31). The second speed is the conveyance speed determined based on the type of the recording medium when the previous print job is executed. In a case in which the sheet feed tray used for the previous print job is the same as the sheet feed tray used for the print job scheduled to be executed next, it is highly probable that the types of the recording media are also the same.

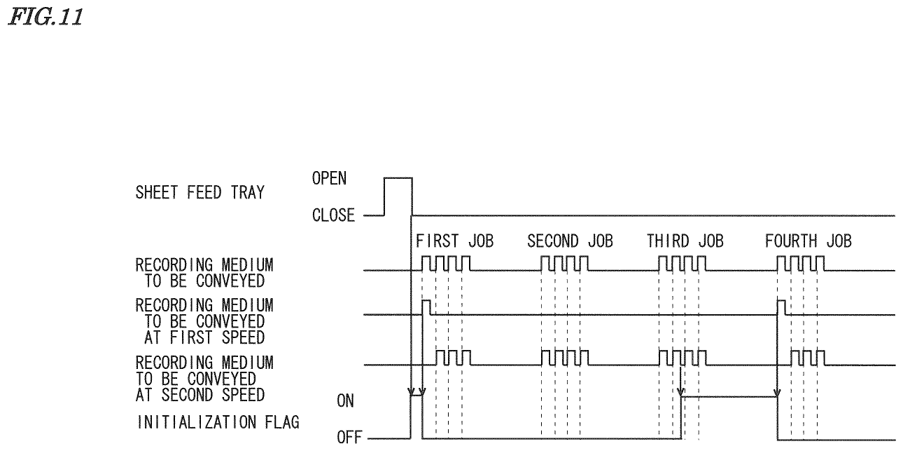

FIG. 11 is a diagram illustrating one example of a time chart. With reference to FIG. 11, the state of a sheet feed tray, the state of a recording medium to be conveyed, the state of a recording medium to be conveyed at the first speed, the state of a recording medium to be conveyed at the second speed, and the state of an initialization flag are illustrated in this order from the top. The state of a sheet feed tray indicates whether the sheet feed tray 151 storing a recording medium to be conveyed is open or closed. The state in which the sheet feed tray 151 is opened is indicated by a high position in the graph, and a state in which the sheet feed tray 151 is closed is indicated by a low position in the graph. In regard to the state of a recording medium to be conveyed, the state in which a recording medium is conveyed is indicated by a high position in the graph. The state in which a recording medium is not conveyed is indicated by a low position in the graph. In regard to the state of a recording medium to be conveyed at the first speed, the state in which a recording medium is conveyed at the first speed is indicated by a high position in the graph, and the state in which a recording medium is not conveyed at the first speed is indicated by a low position in the graph. In regard to the state of a recording medium to be conveyed at the second speed, the state in which a recording medium is conveyed at the second speed is indicated by a high position in the graph, and the state in which a recording medium is not conveyed at the second speed is indicated by a low position in the graph. In regard to the state of an initialization flag, the state in which an initialization flag set to ON is indicated by a high position in the graph, and the state in which an initialization flag set to OFF is indicated by a low position in the graph.

Here, four print jobs including a first job to a fourth job are executed in the MFP 100. Each of the four print jobs including the first job to the fourth job includes four pages.

First, with the initialization flag set to OFF, in response to detection of a close state of the sheet feed tray 151 after detection of an open state, the initialization flag is set to ON. Thereafter, in a case in which the first job is executed, a recording medium on which the image for the first page is to be formed is conveyed from the sheet feed tray 151 at the first speed. An attenuation rate and a transmittance are measured in a period during which the recording medium on which the image for the first page is to be formed is conveyed at the first speed, and the second speed is determined as the conveyance speed of the recording medium.

Then, a recording medium on which the image for the second page of the first job is to be formed is conveyed from the sheet feed tray 151 at the second speed. An attenuation rate and a transmittance are measured in a period during which the recording medium on which the image for the first page is to be formed is conveyed at the first speed, and the medium speed of the recording medium is determined. In a case in which the medium speed is equal to the second speed, the second speed is maintained. Similarly, a recording medium on which the image for each of the third page and the fourth page of the first job is to be formed is conveyed at the second speed.

Next, a second job is executed without opening or closing of the sheet feed tray 151. Because the recording media stored in the sheet feed tray 151 are not changed after execution of the first job, the conveyance speed is maintained at the second speed. Therefore, similarly to the second to fourth pages included in the first job, a recording medium on which the image for each of the first page to the fourth page included in the second job is to be formed is conveyed from the sheet feed tray 151 at the second speed.

Next, a third job is executed without opening or closing of the sheet feed tray 151. Because the recording media stored in the sheet feed tray 151 are not changed after execution of the first job, the conveyance speed is maintained at the second speed. Therefore, similarly to the second to fourth pages included in the first job, a recording medium on which the image for the first page included in the third job is to be formed is conveyed from the sheet feed tray 151 at the second speed. A recording medium on which the image for the second page of the first job is to be formed is conveyed from the sheet feed tray 151 at the second speed. An attenuation rate and a transmittance are measured in a period during which a recording medium on which the image for the second page of the third job is to be formed is conveyed at the second speed, and the medium speed of the recording medium is determined. In a case in which the medium speed is the third speed different from the second speed, the initialization flag is set to ON, and the second speed is maintained as the conveyance speed. The medium speed is the third speed in a case in which a plurality of types of recording media are stored in the sheet feed tray 151. Similarly to a case in which a recording medium on which the image for the second page is to be formed is conveyed, a recording medium on which the image for each of the third page and the fourth page of the third job is to be formed is conveyed at the second speed.

Next, a fourth job is executed without opening or closing of the sheet feed tray 151. Because the initialization flag is set to ON, a recording medium on which the image for the first page of the fourth job is to be formed is conveyed from the sheet feed tray 151 at the first speed. An attenuation rate and a transmittance are measured in a period during which the recording medium on which the image for the first page is to be formed is conveyed at the first speed, and the second speed is determined as the conveyance speed of the recording medium.

Next, the recording medium on which an image for the second page of the fourth job is to be formed is conveyed from the sheet feed tray 151 at the second speed. An attenuation rate and a transmittance are measured in a period during which the recording medium on which the image for the first page is to be formed is conveyed at the first speed, and the medium speed of the recording medium is determined. If the medium speed is equal to the second speed, the second speed is maintained. Similarly, the recording medium on which the image for each of the third page and the fourth page of the first job is to be formed is conveyed at the second speed.

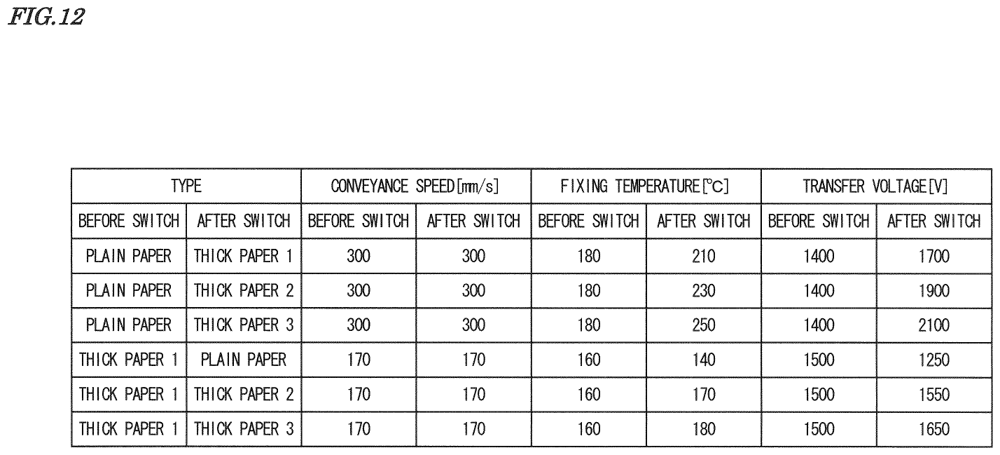

FIG. 12 is a diagram illustrating one example of a change in image forming condition with respect to one example of a change in type of a recording medium. With reference to FIG. 12, one example of a conveyance speed, a fixing temperature and a transfer voltage for each of before and after the type of a recording medium is switched is illustrated. The first row corresponds to a case in which the type of a recording medium is switched from the plain paper to the thick paper 1, the second row corresponds to a case in which the type of a recording medium is switched from the plain paper to the thick paper 2, the third row corresponds to a case in which the type of a recording medium is switched from the plain paper to the thick paper 3, the fourth row corresponds to a case in which the type of a recording medium is switched from the thick paper 1 to the plain paper, the fifth row corresponds to a case in which the type of a recording medium is switched from the thick paper 1 to the thick paper 2, and the sixth row corresponds to a case in which the type of a recording medium is switched from the thick paper 1 to the thick paper 3.

A conveyance speed does not change and stays the same before and after the type of a recording medium is switched. In contrast, a fixing temperature and a transfer voltage change before and after the type of a recording medium is switched.

As illustrated in the first row, in a case in which the type of a recording medium is switched from the plain paper to the thick paper 1, although the conveyance speed is constant at 300 mm/s, the fixing temperature is switched from 180° C. to 210° C., and the transfer voltage is switched from 1400 V to 1700 V. Similarly, as illustrated in each of the second row, the third row, the fifth row and the sixth row, in a case in which a recording medium is changed from a recording medium having a small basis weight to a recording medium having a large basis weight, the fixing temperature and the transfer voltage are switched from small values to large values.

As illustrated in the fourth row, in a case in which the type of a recording medium is switched from the thick paper 1 to the plain paper, although the conveyance speed is constant at 170 mm/s defined for the thick paper 1, the fixing temperature is switched from 160° C. to 140° C., and the transfer voltage is switched from 1500 V to 1250 V. In a case in which a recording medium changes from a recording medium having a large basis weight to a recording medium having a small basis weight, the fixing temperature and the transfer voltage are switched from large values to small values.

An amount of heat applied to a recording medium by the fixing roller 49 is defined for the type of a recording medium. Since a different amount of heat is applied to each of different recording media by the fixing roller 49, a fixing temperature is defined by a table or an arithmetic expression defining the relationship between a fixing temperature and a conveyance speed. Similarly, an amount of work to be applied to a toner by a magnetic field generated by the transfer roller 47 is defined for the type of a recording medium. Since different amounts of work are applied when conveyance speeds are different, a transfer voltage is defined by a table or an arithmetic expression defining the relationship between the transfer voltage and the conveyance speed for each type of a recording medium.

### First Modification Example

In regard to the MFP 100 in the above-mentioned embodiment, an attenuation rate and a transmittance are measured for each of all of a plurality of pages included in a print job, and the type of a recording medium is determined. In regard to the MFP 100 in a first modification example, after the second speed is selected, the attenuation rate and the transmittance of a recording medium on which the image for any one page among a plurality of pages included in a print job is to be formed are measured, and the type of a recording medium is determined. Any one page is the last page, for example. For example, the attenuation rate and the transmittance of the recording medium which is conveyed firstly and on which the image for the first page of the print job is to be formed are measured, the type of the recording medium being conveyed firstly is determined, and the second speed is selected based on the type. Then, the attenuation rate and the transmittance of the recording medium which is conveyed lastly and on which the image for the last page of the print job is to be formed are measured, the type of the recording medium being conveyed lastly is compared with the type of the recording medium being conveyed firstly. Then, it is detected that the type of the recording medium being conveyed firstly is different from the type of the recording medium being conveyed lastly. In this case, the attenuation rate and the transmittance of each of the two recording media on which the images for the first and the last pages among the plurality of pages included in the print job are to be formed are measured, and the attenuation rate and the transmittance of each of the other one or more recording media are not measured. Therefore, the power consumption of the ultrasonic sensor 29 and the optical sensor 30 is reduced, and a load on the CPU 111 is reduced.

Further, in a case in which a plurality of print jobs are successively executed, when the same sheet feed tray is used for a prior print job and a subsequent print job, recording media on which the images for a plurality of pages included in the subsequent print job are to be formed are conveyed at the second speed selected for the subsequent print job at the time of execution of the prior print job. In this case, the attenuation rate and the transmittance of a recording medium on which the image for any one of the plurality of pages included in the subsequent print job is to be formed are measured, and the attenuation rate and the transmittance of the other one or more recording media are not measured. In this case, the power consumption of the ultrasonic sensor 29 and the optical sensor 30 is further reduced, and a load on the CPU 111 is further reduced.

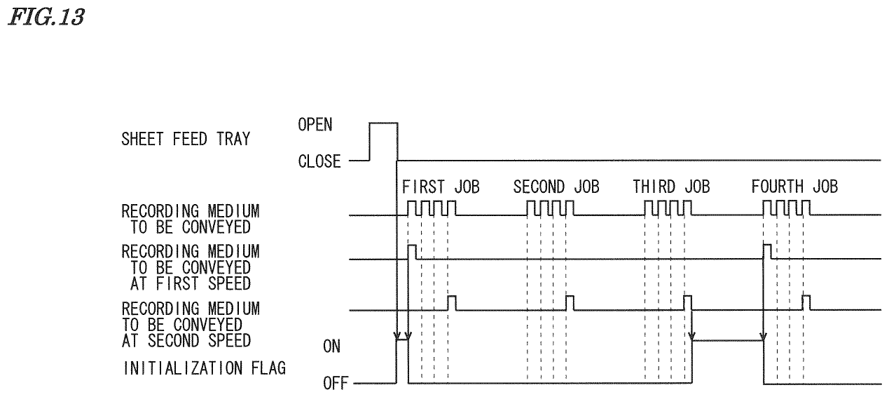

FIG. 13 is a diagram illustrating one example of a time chart in a first modification example. With reference to FIG. 13, the state of a sheet feed tray, the state of a recording medium to be conveyed, the state of a recording medium that is to be conveyed at the first speed and the attenuation rate and the transmittance of which are measured, the state of a recording medium that is to be conveyed at the second speed and the attenuation rate and the transmittance of which are measured, and the state of an initialization flag are illustrated in this order from the top.

Here, four print jobs including a first job to a fourth job are executed in the MFP 100. Each of the four print jobs including the first job to the fourth job includes four pages.

First, with the initialization flag set to OFF, in response to detection of a close state of the sheet feed tray 151 after detection of an open state, the initialization flag is set to ON. Thereafter, in a case in which the first job is executed, a recording medium on which the image for the first page is to be formed is conveyed from the sheet feed tray 151 at the first speed. An attenuation rate and a transmittance are measured in a period during which the recording medium on which the image for the first page is to be formed is conveyed at the first speed, and the second speed is determined as the conveyance speed of the recording medium.

Then, the recording medium on which the image for each of the second page to the fourth page of the first job is to be formed is conveyed from the sheet feed tray 151 at the second speed. The attenuation rate and the transmittance are not measured in a period during which the two recording media on which the images for the second page and the third page are to be respectively formed are conveyed at the second speed. The attenuation rate and the transmittance of the recording medium on which the fourth page that is the last page of the first job is to be formed are measured, and the medium speed is determined. If the medium speed is equal to the second speed, the second speed is maintained.

Next, the second job is executed without opening or closing of the sheet feed tray 151. Because the recording media stored in the sheet feed tray 151 are not changed after execution of the first job, the conveyance speed is maintained at the second speed. Therefore, similarly to the second and third pages included in the first job, the recording medium on which the image for each of the first page to the third page included in the second job is to be formed is conveyed from the sheet feed tray 151 at the second speed. During this period, the attenuation rate and the transmittance are not measured. The attenuation rate and the transmittance of the recording medium on which the fourth page that is the last page of the second job is to be formed are measured, and the medium speed is determined. If the medium speed is equal to the second speed, the second speed is maintained.

Next, the third job is executed without opening or closing of the sheet feed tray 151. Because the recording media stored in the sheet feed tray 151 are not changed after execution of the first job, the conveyance speed is maintained at the second speed. Therefore, the recording medium on which the image for each of the first page to the fourth page of the third job is to be formed is conveyed from the sheet feed tray 151 at the second speed. The attenuation rate and the transmittance are not measured in a period during which the three recording media on which the images for the first page to the third page are respectively formed are conveyed at the second speed. The attenuation rate and the transmittance of the recording medium on which the fourth page that is the last page of the third job is to be formed are measured, and the medium speed is determined. In a case in which the medium speed is the third speed which is different from the second speed, the initialization flag is set to ON, and the second speed is maintained as the conveyance speed. The medium speed is the third speed in a case in which a plurality of types of recording media are stored in the sheet feed tray 151. Similarly to a case in which a recording medium on which the image for the second page is to be formed is conveyed, a recording medium on which the image for each of the third page and the fourth page of the third job is to be formed is conveyed at the second speed.

Next, the fourth job is executed without opening or closing of the sheet feed tray 151. Because the initialization flag is set to ON, a recording medium on which the image for the first page of the fourth job is to be formed is conveyed from the sheet feed tray 151 at the first speed. An attenuation rate and a transmittance are measured in a period during which a recording medium on which the image for the first page is to be formed is conveyed at the first speed, and the second speed is determined as the conveyance speed of the recording medium.

Then, a recording medium on which the image for each of the second page to the fourth page of the fourth job is to be formed is conveyed from the sheet feed tray 151 at the second speed. An attenuation rate and a transmittance are not measured in a period during which two recording media on which the images for the second page and the third page are to be respectively formed are conveyed at the second speed. The attenuation rate and the transmittance of a recording medium on which the image for the fourth page that is the last page of the fourth job is to be formed are measured, and the medium speed is determined. If the medium speed is equal to the second speed, the second speed is maintained.

### Second Modification Example

In the above-mentioned embodiment, the MFP 100 determines the type of a recording medium based on the measured attenuation rate and the measured transmittance while conveying the recording medium at the first speed, and determines the second speed as the medium speed based on the determined type. After the second speed is determined as the medium speed, the MFP 100 determines the type of a recording medium based on the measured attenuation rate and the measured transmittance while conveying the recording medium at the second speed, and determines the medium speed based on the determined type. Then, in a case in which the medium speed is different from the second speed, the medium speed is set to the third speed.

The MFP 100 in second modification example does not determine the type of a recording medium after the second speed is selected. In a case in which the attenuation rate and the transmittance are changed by a predetermined ratio, the MFP 100 detects the switch of the type of a recording medium. Specifically, the CPU 111 included in the MFP 100 stores the measured attenuation rate and the measured transmittance as reference values while conveying a recording medium at the first speed. After that, the CPU 111 conveys a recording medium to be conveyed afterward at the second speed, and compares the attenuation rate and the transmittance of the recording medium with the reference values. In a case in which the attenuation rate and the transmittance are different from the reference values by a predetermined ratio or more, it is determined that the type of a recording medium has been changed. In this case, any value different from the second speed is set for the third speed, or a flag indicating that the type of a recording medium has been changed is displayed. Because the type of a recording medium is not specified, a load on the CPU 111 can be reduced.

As described above, the MFP 100 in the present embodiment includes the sheet feed section 150 that conveys a recording medium, and the ultrasonic sensor 29 and the optical sensor 30 that detect information about the recording medium conveyed by the sheet feed section 150. The ultrasonic sensor 29 outputs the attenuation rate of an ultrasonic wave as the information about the recording medium, and the optical sensor 30 outputs the transmittance of light as the information about the recording medium. In a case in which executing a print job for formation of images for a plurality of pages, the CPU 111 causes the sheet feed section 150 to convey the recording medium being conveyed firstly and corresponds to the first page at the first speed which is an initial value. At this time, the conveyance speed of a recording medium is determined based on the attenuation rate and the transmittance measured by the ultrasonic sensor 29 and the optical sensor 30. In a case in which the determined conveyance speed is different from the first speed, the CPU 111 causes the sheet feed section 150 to convey the recording media that are conveyed secondly and subsequently and are conveyed later than a recording media being conveyed firstly at the second speed different from the first speed. In a case in which the medium speed which is the conveyance speed of a recording medium determined based on the measured attenuation rate and the measured transmittance of a recording medium which is conveyed firstly at the first speed is different from the first speed, the recording media that are conveyed secondly and subsequently and are conveyed later than the recording medium being conveyed firstly are conveyed at the second speed different from the first speed. Therefore, images can be successively formed without interruption of image formation on a plurality of recording media.

The second speed which is the medium speed determined based on the measured attenuation rate and the measured transmittance of the recording medium which is conveyed firstly at the first speed is determined as the conveyance speed of the recording media being conveyed firstly and subsequently. Therefore, an image is formed at the conveyance speed suitable for a recording medium, so that degradation in image quality can be suppressed.

Further, because the second speed is higher than the first speed, it is possible to shorten a period of time required for image formation on a plurality of recording media as much as possible.

Further, in a case in which, during execution of a print job, the conveyance speed of a recording medium that is determined based on the measured attenuation rate and the measured transmittance of the recording medium that is conveyed secondly at the second speed is the third speed which is different from the second speed, the CPU 111 conveys recording media on which the images for a plurality of pages included in the print job are to be formed at the second speed, and conveys the recording medium which is conveyed firstly and on which the image for the first page of the next print job is to be formed at the first speed. Therefore, because a process of executing the print job is not interrupted, the print job can be efficiently executed. Further, because the recording medium which is conveyed firstly and corresponds to the first page of the print job that is to be accepted after the print job in progress is conveyed at the first speed, it suppresses degradation in image quality of an image to be formed on a recording medium when the print job that is to be accepted next is executed.

Further, in a case in which, during execution of a print job, the conveyance speed of a recording medium determined based on the measured attenuation rate and the measured transmittance of the recording medium being conveyed secondly at the second speed is the second speed, the CPU 111 conveys, at the second speed, the recording medium which is conveyed firstly and on which the image for the first page of the next print job is to be formed. Therefore, because the recording medium following the plurality of successive recording media is conveyed at an appropriate conveyance speed, a period of time required for formation of images on recording media for the next print job can be shortened. Further, because the recording medium following the plurality of recording media are conveyed at the second speed, degradation in image quality of the images to be formed on the subsequent recording media is suppressed.

Further, the CPU 111 determines the type of a recording medium based on the attenuation rate and the transmittance of the recording medium measured by the ultrasonic sensor 29 and the optical sensor 30, and determines a conveyance speed defined for the type of the recording medium. The CPU 111 determines the type of at least one of the recording media being conveyed secondly and subsequently among the plurality of successive recording media corresponding to the plurality of pages of the print job. Therefore, because the number of measurement by the ultrasonic sensor 29 and the optical sensor 30 is reduced, the electric power consumed by the ultrasonic sensor 29 and the optical sensor 30 can be reduced.

After selecting the second speed, the CPU 111 does not change the conveyance speed until the print job is completed. Therefore, the print job can be efficiently executed.

Further, after the second speed is selected, the CPU 111 reduces the sampling count of each of the ultrasonic sensor 29 and the optical sensor 30. Therefore, electric power consumed by the ultrasonic sensor 29 and the optical sensor 30 can be reduced.

Further, in a case in which, during execution of a print job, after the second speed is selected, the attenuation rate and the transmittance of the recording medium measured by the ultrasonic sensor 29 and the optical sensor 30 are changed by a predetermined ratio, the CPU 111 in the first modification example conveys the remaining recording media at the second speed, and conveys, at the first speed, the recording medium which is conveyed firstly and on which the image for the first page of the next print job is to be formed. Therefore, because execution of the print job in progress is not interrupted, the print job can be completed as scheduled. Further, because the CPU 111 conveys, at the first speed, the recording medium which is conveyed firstly and on which the image for the first page of the next print job is to be formed, degradation in image quality of the image to be formed on the recording medium in the next print job is suppressed.

### Overview of Embodiments

(Item 1) An image forming apparatus includes a conveyor that successively conveys a plurality of recording media, a medium detector that detects information about the recording medium conveyed by the conveyor; and a hardware processor, wherein the hardware processor detects the information about the recording medium being conveyed firstly by the conveyor at a first speed by using the media detector, and outputs a conveyance speed of the recording medium determined based on the detected information, and in a case in which the output conveyance speed is different from the first speed, carries out control such that a conveyance speed of at least one of recording media which are conveyed secondly and subsequently by the conveyor and are conveyed later than a recording medium being conveyed firstly is a second speed different from the first speed.

According to this aspect, in a case in which the conveyance speed of a recording medium determined based on the information about the recording medium which is conveyed firstly at the first speed is output, and the output conveyance speed is different from the first speed, the conveyance speed of at least one of recording media that are conveyed secondly and subsequently and are conveyed later than a recording media being conveyed firstly is controlled to be the second speed different from the first speed. Therefore, it is possible to provide an image forming apparatus capable of successively forming images on a plurality of recording media without interruption of image formation.

(Item 2) The image forming apparatus according to item 1, wherein a conveyance speed of the recording medium determined based on the information is the second speed.

According to this aspect, the conveyance speed of at least one of the recording media being conveyed secondly and subsequently is set to the conveyance speed of a recording medium determined based on the information about the recording medium which is conveyed firstly at the first speed. Therefore, an image is formed at the conveyance speed suitable for the recording medium, so that degradation in image quality can be suppressed.

(Item 3) The image forming apparatus according to item 1 or 2, wherein the hardware processor, in a case in which the conveyance speed of the recording medium determined based on the information is different from the first speed, determines the second speed that is higher than the first speed as a conveyance speed of the recording media being conveyed secondly and subsequently.

According to this aspect, because the recording media being conveyed secondly and subsequently are conveyed at the second speed higher than the first speed, a period of time required for image formation on a plurality of recording media can be shortened as much as possible.

(Item 4) The image forming apparatus according to any one of items 1 to 3, wherein the hardware processor, in a period during which the plurality of successive recording media are conveyed by the conveyor, in a case in which a conveyance speed of the recording medium determined based on the information is a third speed different from the second speed, conveys rest of the plurality of successive recording media at the second speed and conveys the recording medium being subsequently conveyed after the plurality of successive recording media at the first speed.

According to this aspect, the rest of the plurality of successive recording media are conveyed at the second speed, and the next recording medium following the plurality of successive recording media is conveyed at the first speed. Therefore, image formation on the plurality of successive recording media is not interrupted, so that images are efficiently formed on the plurality of recording media. Further, because the next recording medium following the plurality of recording media is conveyed at the first speed, degradation in image quality of the images to be formed on the next recording media is suppressed.

(Item 5) The image forming apparatus according to item 4, wherein the hardware processor, in a period during which the plurality of successive recording media are conveyed by the conveyor, in a case in which the third speed is not determined as a conveyance speed of the recording medium based on the information, conveys, at the second speed, the next recording medium being conveyed subsequently after the plurality of successive recording media.

According to this aspect, the next recording medium following the plurality of successive recording media is conveyed at the second speed. Therefore, because the next recording medium following the plurality of successive recording media is conveyed at an appropriate conveyance speed, a period of time required for formation of an image on the next recording medium can be shortened as much as possible. Further, because the next recording medium following the plurality of recording media are conveyed at the second speed, degradation in image quality of the images to be formed on the next and subsequent recording media is suppressed.

(Item 6) The image forming apparatus according to any one of items 1 to 5, wherein the hardware processor determines a type of the recording medium based on the information about the recording medium detected by the media detector, determines a conveyance speed defined for the determined type of the recording medium, and after a conveyance speed different from the first speed is output as a conveyance speed of the recording medium determined based on the information, determines the type of at least one of the one or more recording media being conveyed secondly and subsequently.

According to this aspect, the type of at least one of one or more recording media being conveyed secondly and subsequently among the plurality of recording media is determined. Therefore, because the number of times detection is made by the medium detector is reduced, the power consumption can be reduced.

(Item 7) The image forming apparatus according to any one of items 1 to 6, wherein the hardware processor, after a conveyance speed different from the first speed is output as a conveyance speed of the recording medium determined based on the information, does not change a conveyance speed until the plurality of successive recording media are conveyed by the conveyor.

According to this aspect, because the conveyance speed is not changed until the plurality of successive recording media are conveyed by the conveyor, it is possible to efficiently form images on the plurality of recording media.

(Item 8) The image forming apparatus according to any one of items 1 to 7, wherein the media detector reduces a sampling count, for detection of the information about the recording medium conveyed by the conveyor after a conveyance speed different from the first speed is output as a conveyance speed of the recording medium determined based on the information, to be lower than a sampling count for detection before a conveyance speed different from the first speed is output as a conveyance speed of the recording medium determined based on the information.

According to this aspect, after the conveyance speed different from the first speed is output, the sampling count of the medium detector is reduced as compared to the conveyance speed before the conveyance speed different from the first speed is output.

Therefore, it is possible to reduce the power consumption in the medium detector.

(Item 9) The image forming apparatus according to any one of items 1 to 8, wherein the hardware processor, in a period during which the plurality of successive recording media are conveyed by the conveyor, in a case in which the information about the recording medium detected by the media detector changes by a ratio equal to or larger than a predetermined ratio after a conveyance speed different from the first speed is output as a conveyance speed of the recording medium determined based on the information, conveys rest of the plurality of successive recording media at the second speed and conveys the recording media being conveyed subsequently after the plurality of successive recording media at the first speed.

According to this aspect, the rest of the plurality of successive recording media are conveyed at the second speed, and the next recording medium following the plurality of successive recording media is conveyed at the first speed. Therefore, image formation on the plurality of successive recording media is not interrupted, so that images are efficiently formed on the plurality of recording media. Further, because the next recording medium following the plurality of recording media is conveyed at the first speed, degradation in image quality of the images to be formed on the next and subsequent recording media is suppressed.

(Item 10) A conveyance control method performed in an image forming apparatus, wherein the image forming apparatus includes a conveyor that successively conveys a plurality of recording media, and a medium detector that detects information about the plurality of recording media conveyed by the conveyor, and the conveyance control method includes an output step of detecting the information about the recording medium being conveyed firstly by the conveyor at a first speed by using the media detector and outputting a conveyance speed of the recording medium determined based on the detected information, and a conveyance control step of, in a case in which the conveyance speed output in the output step is different from the first speed, carries out control such that a conveyance speed of at least one of recording media which are conveyed secondly and subsequently by the conveyor and are conveyed later than a recording medium being conveyed firstly is a second speed different from the first speed.

According to this aspect, the conveyance control method that enables consecutive image formation on a plurality of recording media without interruption can be provided.

(Item 11) A non-transitory computer-readable recording medium is encoded with a conveyance control program executed in a computer controlling an image forming apparatus, wherein the image forming apparatus includes a conveyor that successively conveys a plurality of recording media, and a medium detector that detects information about the plurality of recording media conveyed by the conveyor, and the conveyance control program causes the computer to perform an output step of detecting the information about the recording medium being conveyed firstly by the conveyor at a first speed by using the media detector and outputting a conveyance speed of the recording medium determined based on the detected information, and a conveyance control step of, in a case in which the conveyance speed output in the output step is different from the first speed, carrying out control such that a conveyance speed of at least one of recording media which are conveyed secondly and subsequently by the conveyor and are conveyed later than a recording medium being conveyed firstly is a second speed different from the first speed.

According to this aspect, it is possible to provide a conveyance control program capable of successively forming images on a plurality of recording media without interrupting the image formation.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus comprising:
a conveyor that successively conveys a plurality of recording media;
a medium detector that detects information about the recording medium conveyed by the conveyor; and
a hardware processor, wherein
the hardware processor
detects the information about the recording medium being conveyed firstly by the conveyor at a first speed by using the media detector, and outputs a conveyance speed of the recording medium determined based on the detected information, and
in a case in which the output conveyance speed is different from the first speed, carries out control such that a conveyance speed of at least one of recording media which are conveyed secondly and subsequently by the conveyor and are conveyed later than a recording medium being conveyed firstly is a second speed different from the first speed.

2. The image forming apparatus according to claim 1, wherein
a conveyance speed of the recording medium determined based on the information is the second speed.

3. The image forming apparatus according to claim 1, wherein
the hardware processor, in a case in which the conveyance speed of the recording medium determined based on the information is different from the first speed, determines the second speed that is higher than the first speed as a conveyance speed of the recording media being conveyed secondly and subsequently.

4. The image forming apparatus according to claim 1, wherein
the hardware processor, in a period during which the plurality of successive recording media are conveyed by the conveyor, in a case in which a conveyance speed of the recording medium determined based on the information is a third speed different from the second speed, conveys rest of the plurality of successive recording media at the second speed and conveys the recording medium being subsequently conveyed after the plurality of successive recording media at the first speed.

5. The image forming apparatus according to claim 4, wherein
the hardware processor, in a period during which the plurality of successive recording media are conveyed by the conveyor, in a case in which the third speed is not determined as a conveyance speed of the recording medium based on the information, conveys, at the second speed, the next recording medium being conveyed subsequently after the plurality of successive recording media.

6. The image forming apparatus according to claim 1, wherein
the hardware processor
determines a type of the recording medium based on the information about the recording medium detected by the media detector,
determines a conveyance speed defined for the determined type of the recording medium, and
after a conveyance speed different from the first speed is output as a conveyance speed of the recording medium determined based on the information, determines the type of at least one of the one or more recording media being conveyed secondly and subsequently.

7. The image forming apparatus according to claim 1, wherein
the hardware processor, after a conveyance speed different from the first speed is output as a conveyance speed of the recording medium determined based on the information, does not change a conveyance speed until the plurality of successive recording media are conveyed by the conveyor.

8. The image forming apparatus according to claim 1, wherein
the media detector reduces a sampling count, for detection of the information about the recording medium conveyed by the conveyor after a conveyance speed different from the first speed is output as a conveyance speed of the recording medium determined based on the information, to be lower than a sampling count for detection before a conveyance speed different from the first speed is output as a conveyance speed of the recording medium determined based on the information.

9. The image forming apparatus according to claim 1, wherein
the hardware processor, in a period during which the plurality of successive recording media are conveyed by the conveyor, in a case in which the information about the recording medium detected by the media detector changes by a ratio equal to or larger than a predetermined ratio after a conveyance speed different from the first speed is output as a conveyance speed of the recording medium determined based on the information, conveys rest of the plurality of successive recording media at the second speed and conveys the recording media being conveyed subsequently after the plurality of successive recording media at the first speed.

10. A conveyance control method performed in an image forming apparatus,
the image forming apparatus comprising:
a conveyor that successively conveys a plurality of recording media; and
a medium detector that detects information about the plurality of recording media conveyed by the conveyor,
the conveyance control method including:
an output step of detecting the information about the recording medium being conveyed firstly by the conveyor at a first speed by using the media detector and outputting a conveyance speed of the recording medium determined based on the detected information; and
a conveyance control step of, in a case in which the conveyance speed output in the output step is different from the first speed, carries out control such that a conveyance speed of at least one of recording media which are conveyed secondly and subsequently by the conveyor and are conveyed later than a recording medium being conveyed firstly is a second speed different from the first speed.

11. The conveyance control method according to claim 10, wherein
a conveyance speed output in the output step is the second speed.

12. The conveyance control method according to claim 10, wherein
the conveyance control step includes, in a case in which the conveyance speed output in the output step is different from the first speed, determining the second speed that is higher than the first speed as a conveyance speed of the recording media being conveyed secondly and subsequently.

13. The conveyance control method according to claim 10, wherein
the conveyance control step includes, in a period during which the plurality of successive recording media are conveyed by the conveyor, in a case in which a third speed different from the second speed is output from the outputter, conveying rest of the plurality of successive recording media at the second speed and conveying the recording medium being subsequently conveyed after the plurality of successive recording media at the first speed.

14. The conveyance control method according to claim 13, wherein
the conveyance control step includes, in a period during which the plurality of successive recording media are conveyed by the conveyor, in a case in which the third speed is not output in the output step, conveying, at the second speed, the next recording medium being conveyed subsequently after the plurality of successive recording media.

15. The conveyance control method according to claim 10, wherein
the output step includes
a type determining step of determining a type of the recording medium based on the information about the recording medium detected by the media detector, and
a conveyance speed determining step of determining a conveyance speed defined for the type of the recording medium determined in the type determining step, and
the type determining step includes, after a conveyance speed different from the first speed is output in the output step, determining the type of at least one of the one or more recording media being conveyed secondly and subsequently.

16. The conveyance control method according to claim 10, wherein
the conveyance control step includes, after a conveyance speed different from the first speed is output in the output step, not changing a conveyance speed until the plurality of successive recording media are conveyed by the conveyor.

17. The conveyance control method according to claim 10, wherein
the media detector reduces a sampling count, for detection of the information about the recording medium conveyed by the conveyor after a conveyance speed different from the first speed is output in the output step, to be lower than a sampling count for detection before a conveyance speed different from the first speed is output in the output step.

18. The conveyance control method according to claim 10, wherein
the conveyance control step includes, in a period during which the plurality of successive recording media are conveyed by the conveyor, in a case in which the information about the recording medium detected by the media detector changes by a ratio equal to or larger than a predetermined ratio after a conveyance speed different from the first speed is output in the output step, conveying rest of the plurality of successive recording media at the second speed and conveying the recording media being conveyed subsequently after the plurality of successive recording media at the first speed.

19. A non-transitory computer-readable recording medium encoded with a conveyance control program executed in a computer controlling an image forming apparatus,
the image forming apparatus comprising:
a conveyor that successively conveys a plurality of recording media; and
a medium detector that detects information about the plurality of recording media conveyed by the conveyor,
the conveyance control program causing the computer to perform:
an output step of detecting the information about the recording medium being conveyed firstly by the conveyor at a first speed by using the media detector and outputting a conveyance speed of the recording medium determined based on the detected information; and
a conveyance control step of, in a case in which the conveyance speed output in the output step is different from the first speed, carrying out control such that a conveyance speed of at least one of recording media which are conveyed secondly and subsequently by the conveyor and are conveyed later than a recording medium being conveyed firstly is a second speed different from the first speed.
